(19) United States
(12) Patent Application Publication
(10) Pub. No.: US 2026/0247190 A1
(43) Pub. Date: Aug. 20, 2026

(54) EARLY DETECTION OF CLI

(71) Applicant: QUALCOMM Incorporated, San Diego, CA (US)

(72) Inventors: Jing LEI, San Diego, CA (US); Weimin DUAN, San Diego, CA (US); Huilin XU, Temecula, CA (US)

(21) Appl. No.: 19/056,575

(22) Filed: Feb. 18, 2025

(51) Int. Cl. H04W 24/10

(52) U.S. Cl. CPC H04W 24/10

(57) ABSTRACT

A method for wireless communication at a first user equipment (UE) and related apparatus are provided. In the method, the first UE measures, at the first UE, cross-link interference (CLI) from a second UE on one or more occasions to obtain a CLI measurement. The first UE further transmits a report based on the CLI measurement to a first network entity associated with the first UE. The CLI is associated with one or more of a random access procedure of the second UE, small data transmission (SDT) by the second UE, positioning of the second UE, radio frequency (RF) sensing of the second UE, or a hand over (HO) of the second UE.

### TECHNICAL FIELD

The present disclosure relates generally to communication systems and, more particularly, to interference management in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first user equipment (UE). The apparatus may include at least one memory and at least one processor coupled to the at least one memory. Based at least in part on information stored in the at least one memory, the at least one processor may be configured to measure, at the first UE, cross-link interference (CLI) from a second UE on one or more occasions to obtain a CLI measurement; and transmit, to a first network entity associated with the first UE, a report based on the CLI measurement. The CLI is associated with one or more of a random access procedure of the second UE, small data transmission (SDT) by the second UE, positioning of the second UE, radio frequency (RF) sensing of the second UE, or a hand over (HO) of the second UE.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to provide resource information indicative of one or more occasions; and receive, from a first UE, a report based on a CLI measurement of CLI from a second UE on the one or more occasions. The CLI measurement indicates the CLI based on a random access procedure of the second UE, SDT by the second UE, positioning of the second UE, RF sensing of the second UE, or an HO of the second UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B illustrate example aspects of random access procedures.

FIG. 5A is a diagram illustrating an example of an inter-cell cross-link interference (CLI).

FIG. 5B is a diagram illustrating an example of an intra-cell CLI.

FIG. 6 is a diagram illustrating example random access occasions for CLI measurements in accordance with various aspects of the present disclosure.

FIG. 7 is a diagram illustrating an example X-shaped frequency-modulated continuous wave (FMCW) waveform for CLI measurements in accordance with various aspects of the present disclosure.

FIG. 8 is a diagram illustrating an example of simultaneous measurements of multiple ROs in accordance with various aspects of the present disclosure.

FIG. 9 is a diagram illustrating example CLI measurements in accordance with various aspects of the present disclosure.

FIG. 10 is a diagram illustrating an example of a CLI reporting mechanism based on a threshold in accordance with various aspects of the present disclosure.

FIG. 11 is a diagram illustrating an example of CLI management in accordance with various aspects of the present disclosure.

FIG. 12 is a call flow diagram illustrating a method of wireless communication in accordance with various aspects of the present disclosure.

FIG. 13 is a flowchart illustrating methods of wireless communication at a first UE in accordance with various aspects of the present disclosure.

FIG. 14 is a flowchart illustrating methods of wireless communication at a first UE in accordance with various aspects of the present disclosure.

FIG. 15 is a flowchart illustrating methods of wireless communication at a network entity in accordance with various aspects of the present disclosure.

FIG. 16 is a diagram illustrating an example of a hardware implementation for an example apparatus and/or UE.

FIG. 17 is a diagram illustrating an example of a hardware implementation for an example network entity.

### DETAILED DESCRIPTION

In wireless communication, cross-link interference (CLI) may occur when uplink (UL) transmissions from a user equipment (UE), referred to as an interfering UE, interfere with downlink (DL) reception of another UE, referred to as an interfered UE. In some aspects, the interfering UE may be referred to as an aggressor UE, and the interfered UE may be referred to as a victim UE or an affected UE. CLI may arise, for example, these two UEs operate with different time-division duplex (TDD) uplink-downlink slot configurations. In some examples, CLI measurement resources may be configured for the interfered UE to perform CLI measurements while the interfered UE is in the radio resource control (RRC) connected state. For example, an interfered UE may measure sounding reference signal (SRS) transmissions from an interfering UE in an RRC connected mode. Such CLI measurement may serve as a simple detection mechanism for the interfered UE and may not provide an accurate representation of the actual CLI strength. Additionally, this CLI measurement method does not detect potential interfering UEs when the interfered UE is in an RRC inactive mode or RRC idle mode, e.g., SRS transmissions are not available. Example aspects presented herein provide techniques for the early detection of potential CLI interfering UEs while an interfering UE is in an RRC inactive or RRC idle state. For example, signals other than SRS, such as random access transmissions for initial access or handover (HO), small data transmission (SDT), or any sensing signals transmitted by potentially interfering UEs may be used by potentially interfered UEs to enable CLI measurement in inactive or idle states. By measuring potential CLI while a UE is in an RRC idle or inactive state, the potential for CLI can be detected early so that the network can take actions to mitigate CLI in a more efficient manner.

Various aspects relate generally to wireless communication. Some aspects more specifically relate to the detection of CLI in wireless communication. In some examples, a first UE may measure CLI at the first UE from a second UE on one or more occasions to obtain a CLI measurement. The first UE may further transmit a report based on the CLI measurement to a first network entity associated with the first UE. The CLI may be associated with one or more of a random access procedure of the second UE, SDT by the second UE, positioning of the second UE, radio frequency (RF) sensing of the second UE, or an HO of the second UE. In some examples, the first UE may receive a random access resource configuration indicating the one or more random access occasions, and the first UE may measure the CLI in the one or more random access occasions. In some examples, the one or more random access occasions may at least partially overlap with an active downlink bandwidth part (BWP) of the first UE. In some examples, the first UE may measure the CLI based on an up-sweep frequency-modulated continuous wave (FMCW) component and a down-sweep FMCW component. In some examples, the cross point of the up-sweep FMCW component and the down-sweep FMCW component in a frequency-time domain may be located at a center of one random access occasion of the one or more random access occasions in the frequency-time domain.

Particular aspects of the subject matter described in this disclosure can be implemented to realize one or more of the following potential advantages. In some examples, by performing CLI measurement based on physical random access channel (PRACH) signals, the described techniques enable early interference identification before the interfering UE transitions to active transmission states, thereby reducing the impact of CLI on interfered UEs and allowing for proactive interference management. In some examples, by utilizing PRACH resources that are periodically available and broadcast to all UEs, the described techniques reduce network overhead for CLI measurement configuration while ensuring efficient resource utilization. In some examples, by implementing a two-step CLI management process, in which initial detection allows the network to selectively trigger more refined CLI measurements, the described techniques improve the accuracy of interference identification and reduce false alarms and unnecessary network actions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

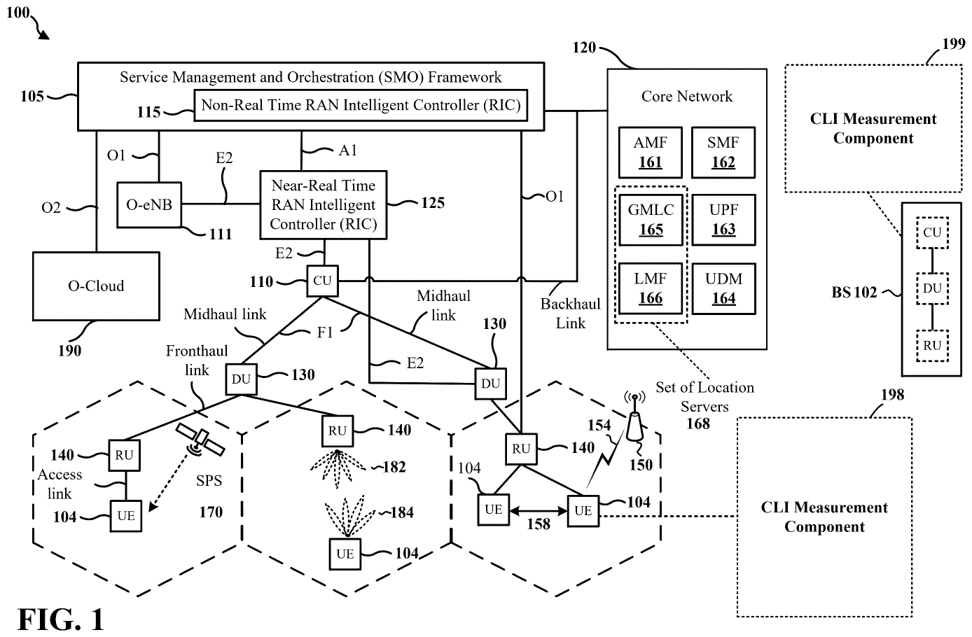

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the CLI measurement component 198. The CLI measurement component 198 may be configured to measure, at the first UE, CLI from a second UE on one or more occasions to obtain a CLI measurement; and transmit, to a first network entity associated with the first UE, a report based on the CLI measurement. The CLI is associated with one or more of a random access procedure of the second UE, SDT by the second UE, positioning of the second UE, RF sensing of the second UE, or an HO of the second UE. In certain aspects, the base station 102 may include the CLI measurement component 199. The CLI measurement component 199 may be configured to provide resource information indicative of one or more occasions; and receive, from a first UE, a report based on a CLI measurement of CLI from a second UE on the one or more occasions. The CLI measurement indicates the CLI based on a random access procedure of the second UE, SDT by the second UE, positioning of the second UE, RF sensing of the second UE, or an HO of the second UE. Although the following description may be focused on 5G NR, the concepts described herein may be applicable to other similar areas, such as LTE, LTE-A, CDMA, GSM, and other wireless technologies.

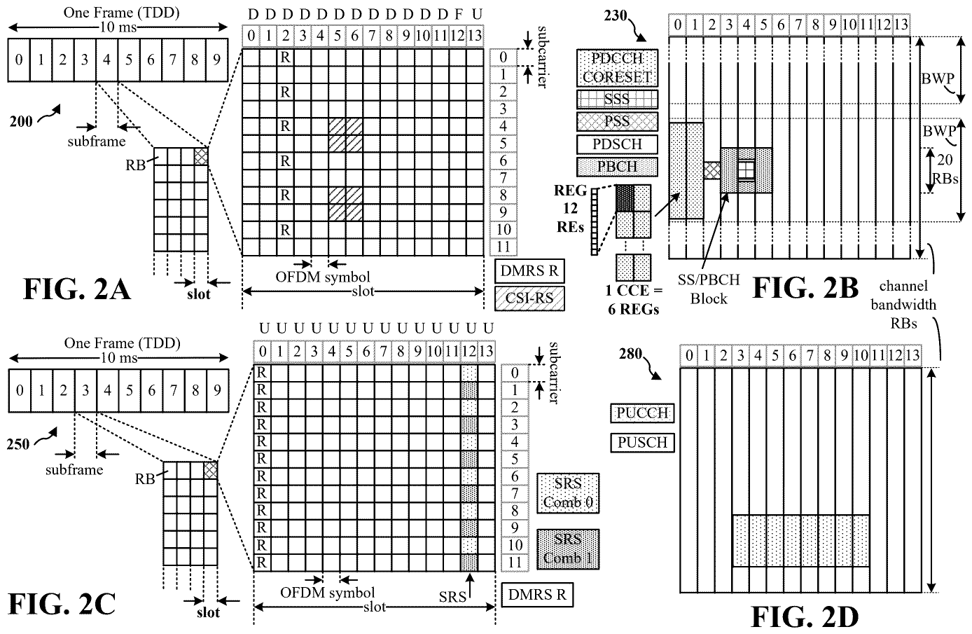

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

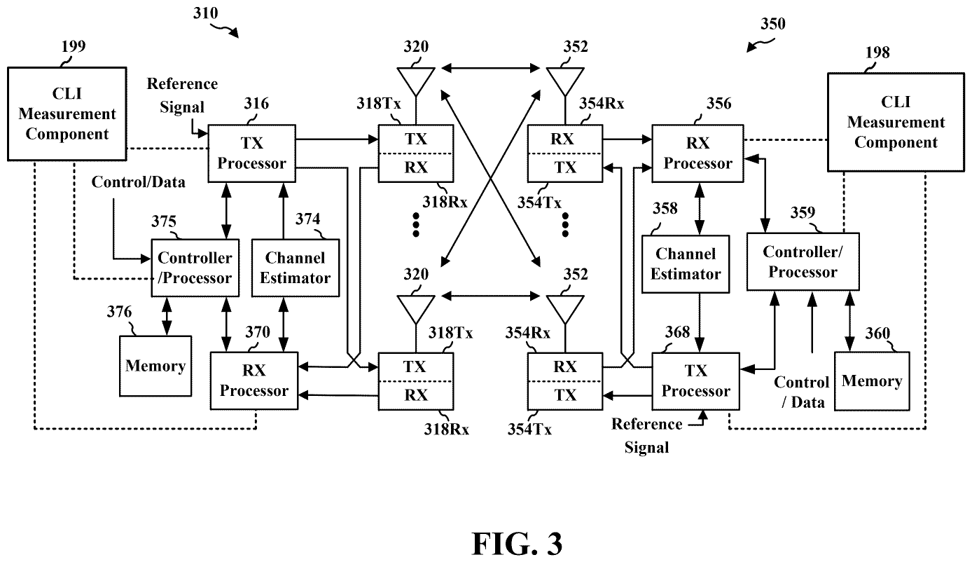

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CLI measurement component 198 of FIG. 1.

At least one of the TX processor 316, the RX processor 370, and the controller/processor 375 may be configured to perform aspects in connection with the CLI measurement component 199 of FIG. 1.

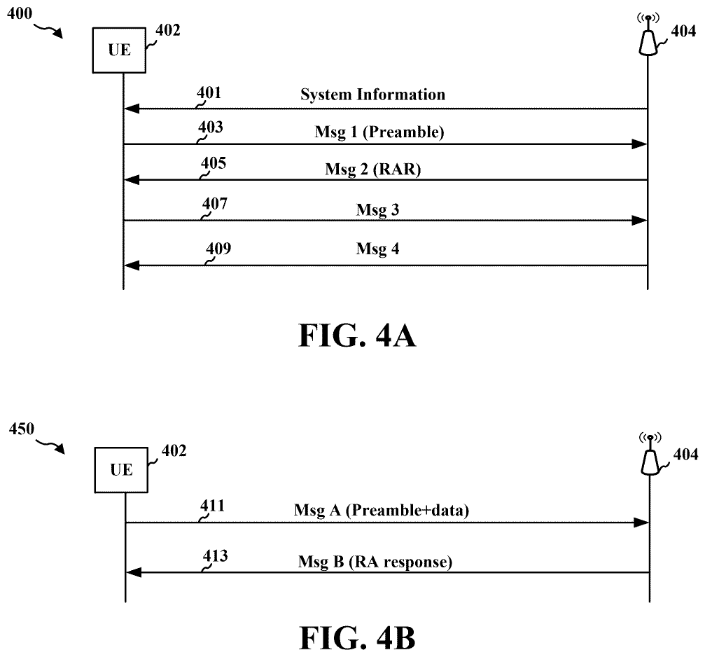

A UE may use a random access procedure in order to communicate with a base station. For example, the UE may use the random access procedure to request an RRC connection, to re-establish an RRC connection, to resume an RRC connection, etc. FIG. 4A illustrates example aspects of a random access procedure 400 between a UE 402 and a base station 404. The UE 402 may initiate the random access message exchange by sending, to the base station 404, a first random access message 403 (e.g., Msg 1) including a preamble. Prior to sending the first random access message 403, the UE 402 may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402.

The base station responds to the first random access message 403 by sending a second random access message 405 (e.g., Msg 2) using PDSCH and including a random access response (RAR). The RAR may include, e.g., an identifier of the random access preamble sent by the UE, a time advance (TA), an uplink grant for the UE to transmit data, a cell radio network temporary identifier (C-RNTI) or other identifier, and/or a back-off indicator. Upon receiving the RAR at 405, the UE 402 may transmit a third random access message 407 (e.g., Msg 3) to the base station 404, e.g., using PUSCH, that may include an RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs send the same preamble at 403, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR.

In order to reduce latency or control signaling overhead, a single round trip cycle between the UE and the base station 404 may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

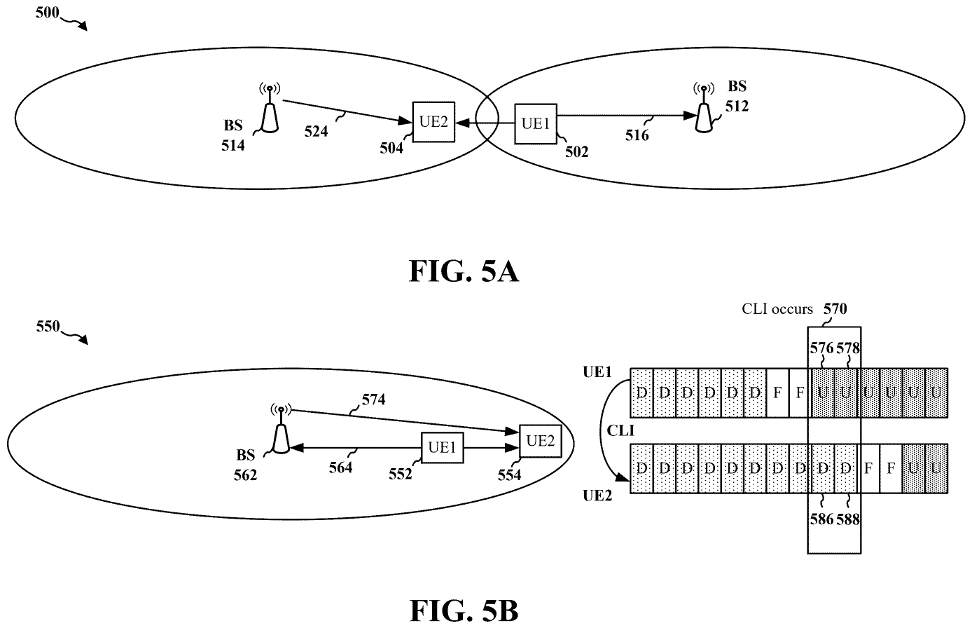

CLI may occur in wireless communication when different UE operate with different time-division duplex (TDD) configurations. These configurations may differ across UEs in both inter-cell and intra-cell scenarios. In an inter-cell scenario, CLI may arise when semi-static TDD uplink (UL) and downlink (DL) configurations differ between neighboring cells. FIG. 5A is a diagram 500 illustrating an example of an inter-cell CLI. As shown in FIG. 5A, a first UE 502 may operate within the first cell (e.g., base station 512), and a second UE 504 may operate within the second cell (e.g., base station 514). The downlink transmission 524 for the second UE 504 with the second cell (e.g., base station 514) may experience interference from the uplink transmission 516 of the first UE 502 to the first cell (e.g., base station 512). This interference (e.g., the CLI) may occur if semi-static TDD uplink and downlink configurations differ between the first cell (e.g., base station 512) and the second cell (e.g., base station 514). In this case, the first UE 502 is an interfering UE and the second UE 504 is an interfered UE.

In an intra-cell scenario, CLI may occur due to UE-specific dynamic TDD UL/DL configurations within the same cell. FIG. 5B is a diagram 550 illustrating an example of an intra-cell CLI. As shown in FIG. 5B, a first UE 552 and a second UE 554 may operate within the same cell (e.g., base station 562). The downlink transmission 574 for the second UE 554 may experience interference from the uplink transmission 564 of the first UE 552. This interference (e.g., the CLI) may occur due to, for example, the overlap of the uplink symbols 576, 578 of the first UE 552 with the downlink symbols 586, 588 of the second UE 554 during the time interval of 570. In this case, the first UE 552 is an interfering UE and the second UE 554 is an interfered UE.

When nearby UEs follow different TDD UL-DL slot formats or in subband full duplex (SBFD) mode, CLI may happen if one UE (e.g., the interfered UE 504, 554) receives an uplink transmission from another UE (e.g., the interfering UE 502, 552). This interference occurs when a UL symbol (e.g., 576, 578) transmitted by the interfering (e.g., UE 552) collides with a DL symbol (e.g., 586, 588) of the interfered UE (e.g., UE 554). Any uplink transmission from the interfering UE (e.g., UE 552) has the potential to cause CLI, leading to unintended disruptions in communication.

In wireless communication, CLI measurement metrics (e.g., the metrics to evaluate the CLI) may include sounding reference signal-reference signal received power (SRS-RSRP) and CLI-received signal strength indicator (CLI-RSSI). These metrics may be measured within the active bandwidth part (BWP) of the interfered UE (e.g., UE 504, 554) while in RRC connected mode. SRS-RSRP may be calculated as the linear average of the power contributions of the SRS measured over the configured resource elements within the considered measurement frequency bandwidth and across the time resources in the configured measurement occasions.

CLI-RSSI represents the linear average of the total received power observed in certain orthogonal frequency-division multiplexing (OFDM) symbols of the measurement time resources. This measurement may be within the measurement bandwidth and over the configured resource elements for measurement by the UE. Both SRS-RSRP and CLI-RSSI measurement reports support both event-triggered (e.g., aperiodic) and periodic reporting. For example, periodic reporting may include the transmission of a report in a periodic manner based on a configuration and without signaling to trigger each individual report. As an example, an aperiodic report may be conditional, e.g., the UE may transmit the aperiodic report based on the occurrence of a condition. In some aspects, the condition may be the reception of a request for the report or a measurement that meets a threshold to trigger a report. For example, a new event, referred to as event L1, may be defined to indicate when interference exceeds a predetermined threshold. In some examples, layer 3 (L3) filtering may be applied to these measurements. For example, for CLI-RSSI, it is up to the UE implementation to determine whether to reset the filtering when a BWP switch occurs. In some examples, no dedicated measurement gap may be needed for these measurements.

In some examples, the measurement configuration for CLI may be based on the frequency grid of the interfered UE (e.g., UE 504, 554). The measurement and report configurations for CLI-RSSI and SRS-RSRP may be independent of each other. For example, the maximum number of configured CLI-RSSI measurement resources may be 64, while the maximum number of configured SRS-RSRP measurement resources may be 32, and the maximum number of CLI measurements that may be included in a single report may be 8.

In some examples, for SRS-RSRP, the configuration parameters may include the parameters used for SRS sequence generation, which may also be used in the same manner as for SRS transmission by the UE. In some examples, a new parameter may be added to define the reference subcarrier spacing (SCS), and the interfered UE (e.g., UE 504, 554) may not measure an SRS resource if the reference SCS is different from that of the active BWP. In some examples, the UE may receive a periodic resource configuration. In some examples, the parameters that are needed for SRS transmission and not CLI measurement may be omitted from the configuration.

In some examples, CLI measurement resources may be configured for the interfered UE (e.g., UE 504, 554) in the RRC connected state. The interfered UE (e.g., UE 504, 554) may measure either SRS-RSRP or CLI-RSSI within the active BWP. These CLI measurements may serve as a simple detection mechanism for the interfered UE (e.g., UE 504, 554), similar to radio resource management (RRM) measurements. Additionally, the L3 filtering may mix measurements from CLI measurement occasions with actual SRS transmissions from the interfering UE (e.g., UE 502, 552) and occasions without SRS transmissions. As a result, L3 CLI measurements may not provide an accurate representation of the actual instantaneous CLI strength.

In some examples, inter-UE CLI may occur in any RRC state (e.g., RRC idle or RRC inactive state) when the interfering UE (e.g., UE 502, 552) is communicating with a base station (e.g., base station 512, 562) operating in TDD or sub-band full duplex (SBFD) mode. Aspects presented herein enable the detection of CLI in an state, e.g., including in an RRC idle or RRC inactive state. For example, CLI detection and management may be enhanced to improve throughput performance, interference management, and scheduling efficiency. In some examples, CLI detection and management may be enhanced to reduce the overhead and latency associated with CLI measurement and reporting. Example aspects presented herein provide techniques for the early detection of potential CLI interfering UEs (e.g., UE 502, 552) while they are in RRC inactive or idle states. For example, an interfered UE (e.g., UE 504, 554) may use signals other than SRS, which are transmitted by interfering UEs (e.g., UE 502, 552) in RRC inactive or idle states, for CLI measurement. These signals may include RACH transmissions for initial access or HO, SDT, or any sensing signals, such as positioning or RF sensing signals, when the interfering UEs (e.g., UE 502, 552) are in RRC inactive or idle states.

The early CLI detection methods presented in example aspects offer various benefits. In some examples, each PRACH resource (e.g., PRACH resources for transmitting Msg 1 at 403 or Msg A at 411) may span multiple and consecutive symbols or slots, which may provide greater flexibility for UE's measurements (for full or partial measurements). This structure makes PRACH-based measurements more reliable than one-shot measurement using symbol-level SRS and other resources, such as demodulation reference signal (DMRS). In some examples, PRACH resources may be periodically available, and their resource indication may be broadcast to all UEs through system information (SI), such as SI at 401. This periodic availability reduces network overhead associated with CLI reference signal allocation and signaling and improves the overall resource utilization efficiency of the network. In contrast, SRS and other resources such as DMRS are dependent on network scheduling decisions. For example, if a UE does not transmit SRS or DMRS, or if the scheduling information of the interfering UEs (e.g., UE 502, 552) is unavailable to the interfered UE (e.g., UE 504, 554), the interfered UE (e.g., UE 504, 554) may not be able to detect CLI before it is affected. Additionally, in some examples, a UE may not transmit DMRS or SRS in an idle or inactive state without timing advance (TA). This limitation restricts the use of DMRS or SRS based CLI measurement or detection for potential interfering UE that is in an RRC idle or inactive state. Example aspects presented herein provide PRACH-based measurement approach that reduces the latency of CLI detection and enables more efficient CLI management for the network. Example aspects presented herein provide early detection and indication and, in some examples, may further enable subsequent CLI measurements (e.g., CLI measurements based on SRS or other opportunistic reference signals scheduled by the network).

In some examples, when there is no timing synchronization between the interfered and interfering UEs in the uplink, PRACH-based detection serves as a more effective solution. For example, each PRACH occasion, with or without repetition, may span multiple symbols or slots consecutively in the time domain, making it a more reliable measurement source compared to symbol-level SRS or DMRS. In some examples, the network may configure CLI management based on conditions (with or without assistance from artificial intelligence or machine learning (AI/ML) algorithms), and the network may aggregate multiple UEs' reporting data to accurately verify the identity of interfering UEs with high reliability.

In some aspects, the CLI measurements may be based on PRACH signals (which may also be referred to as random access signals or random access transmissions), such as Msg 1 at 403 or Msg A at 411. For example, PRACH signals may either use the waveform based on the Zadoff-Chu (ZC) sequence or adopt a new waveform with higher resolution for timing and frequency offset detection, such as X-shaped or V-shaped frequency-modulated continuous wave (FMCW). In some examples, to detect a potential interfering UE (e.g., UE 502, 552) for CLI, an interfered UE (e.g., UE 504, 554) in the RRC connected state may measure PRACH resources (e.g., PRACH resources for transmitting Msg 2 at 403 or Msg A at 411) that are semi-statically configured in both time and frequency domains. For PRACH resource configurations (e.g., random access resource configurations) that are cell-specific, without additional overhead for CLI reference signal allocation, unlike SRS-based measurements.

In some examples, for intra-cell CLI measurements, the UE (e.g., UE 554) may obtain PRACH resource configuration from the SI of its serving cell (e.g., base station 562). In inter-cell CLI measurements, the UE (e.g., UE 504) may acquire PRACH resource configuration either by obtaining SI from a neighboring cell (e.g., base station 512) or through network assistance information provided by the serving cell (e.g., base station 514).

In some examples, if multiple random access occasions (ROs) have been configured within a PRACH configuration period, the UE (e.g., UE 504, 554) may measure one or multiple ROs that overlap or partially overlap with the UE's active downlink BWP. For example, an RO may occupy an time interval in the time domain and a frequency range in the frequency domain. An RO is considered to “overlap” with a BWP if its frequency range fully or partial coincides with the frequency range of the BWP.

In some examples, the CLI measurements may be performed periodically or aperiodically. For example, aperiodic measurements may be triggered by downlink control information (DCI) or medium access control (MAC)-control elements (MAC-CE) from the serving cell, for example, when an interfering UE (e.g., UE 502, 552) is performing RACH during a handover (HO) or secondary cell (SCell) switching.

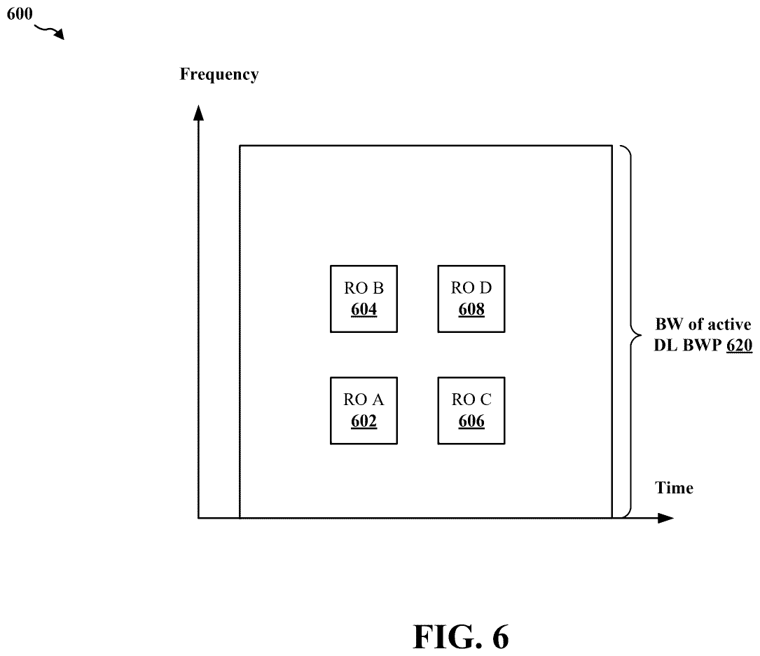

FIG. 6 is a diagram 600 illustrating example random access occasions for CLI measurements in accordance with various aspects of the present disclosure. As shown in FIG. 6, in some examples, a UE may measure PRACH transmissions on an RO group that includes multiple ROs, including RO A 602, RO B 604, RO C 606, RO D 608, when the UE's DL is associated or quasi-co-located (QCL) with a synchronization signal block (SSB) beam (e.g., beam n). In this case, all ROs (e.g., RO A 602, RO B 604, RO C 606, RO D 608) in the RO group may be mapped to the specific SSB beam (e.g., beam n) according to the SSB-to-RO association pattern indicated by the network in SI, and the ROs (e.g., RO A 602, RO B 604, RO C 606, RO D 608) may overlap or partially overlap with the UE's active DL BWP 620. For example, the frequency ranges of the ROs (e.g., RO A 602, RO B 604, RO C 606, RO D 608) may overlap or partially overlap with the UE's active DL BWP 620. In some examples, an RO may be represented by an index of RO, which may be a random access radio network temporary identifier (RA-RNTI). An RA-RNTI may be a function of time and frequency resources. The RA-RNTI associated with an RO in which the random access preamble is transmitted may be computed using the following formula:

RA-RNTI=1+s_{id}+14×t_{id}+14×80×f_{id}+14×80×8×ul_carrier_id (1)

where s_{id} is the index of the first orthogonal frequency division multiplexing (OFDM) symbol of the RO, where 0<s_{id}<14. The parameter t_{id} is the index of the first slot of the RO within a system frame, with 0<t_{id}<80. t_{id} may be determined based on the subcarrier spacing, which is based on the value of u specified for u={0,1,2,3}. For u={5,6}, t_{id} is the index of the 120 kHz slot in a system frame that contains the RO, where 0<t_{id}<80. f_{id} is the index of the RO in the frequency domain, with 0<f_{id}<8, ul_carrier_id is the uplink carrier utilized for the random access preamble transmission. For example, ul_carrier_id may be 0 for a normal uplink (NUL) carrier and 1 for a supplementary uplink (SUL) carrier.

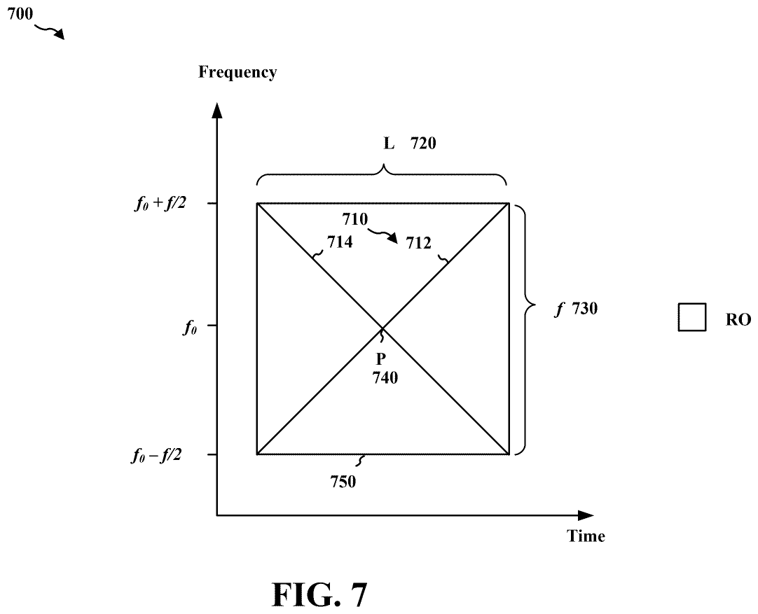

In some aspects, a PRACH waveform based on X-shaped frequency-modulated continuous wave (FMCW) (X-FMCW) may be used as an alternative to a single up-FMCW. FIG. 7 is a diagram 700 illustrating an example X-shaped FMCW waveform for CLI measurements in accordance with various aspects of the present disclosure. As shown in FIG. 7, the X-FMCW waveform 710 may include an up-sweep component 712 and a down-sweep component 714. For example, the up-sweep component 712 and the down-sweep component 714 may be symmetric in the time and frequency domain. For example, as shown in FIG. 7, the up-sweep component 712 and the down-sweep component 714 may span a time interval of L 720 in the time domain and span the frequency interval of f 730 in the frequency domain. The crossing point P 740 of the up-sweep component 712 and down-sweep component 714 may be located at the center of an RO (e.g., RO 750). In some examples, the X-FMCW receiver may perform both the up-sweep and down-sweep simultaneously.

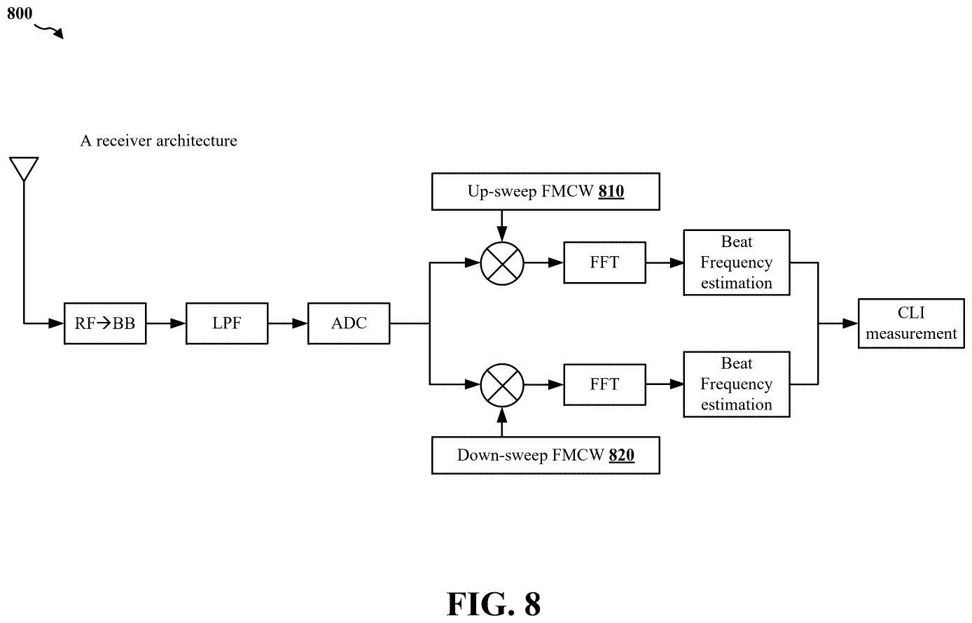

In some examples, multiple ROs may be measured simultaneously for CLI measurements. FIG. 8 is a diagram 800 illustrating an example of simultaneous measurements of multiple ROs in accordance with various aspects of the present disclosure. As shown in FIG. 8, in some examples, an extension is introduced to enable the measurement of multiple ROs simultaneously. For example, the X-FMCW receiver may be configured or implemented to sweep a wider bandwidth, allowing it to check multiple ROs at once. For example, as shown in FIG. 8, the example receiver may be able to simultaneously process an up-sweep FMCW 810 and a down-sweep FMCW 820, and may measure at least eight frequency-division multiplexed (FDMed) ROs within a certain bandwidth (e.g., a bandwidth of 100 MHz).

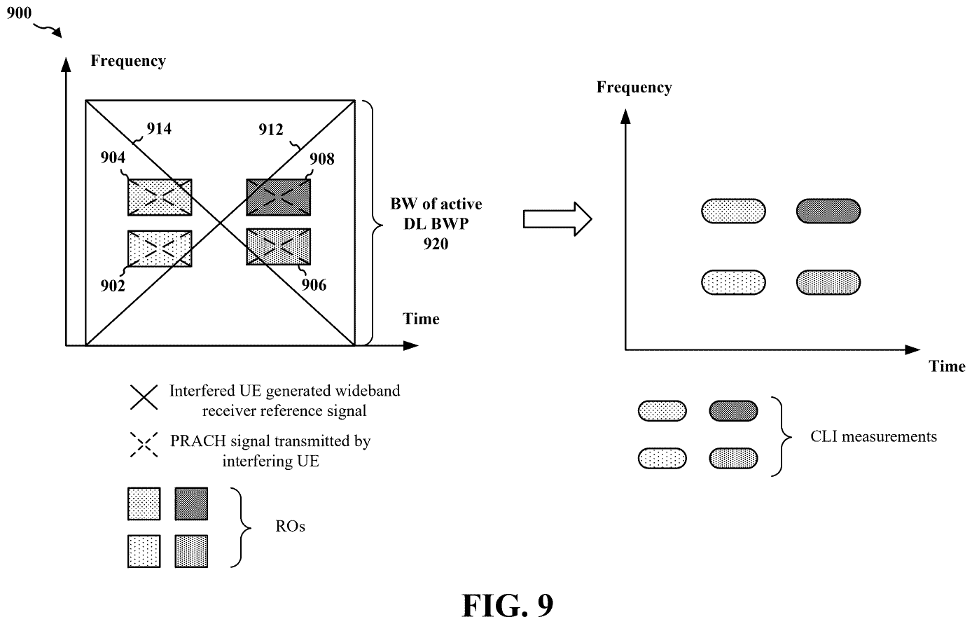

In some examples, the CLI measurement based on, for example, PRACH (or random access) resources may offer various advantages. FIG. 9 is a diagram 900 illustrating example CLI measurements in accordance with various aspects of the present disclosure. As shown in FIG. 9, the up-sweep FMCW component 912 and the down-sweep FMCW component 914 may encompass the one or more random access occasions (e.g., RO 902, 904, 906, 908) in the time domain and the frequency domain. For example, the PRACH-based CLI measurements allow a low-complexity receiver implementation to enable one-shot measurement of multiple ROs (e.g., RO 902, 904, 906, 908) within the active BWP (e.g., DL BWP 920). In some examples, to perform PRACH-based CLI measurements, the UEs may not need to be synchronized or to have prior knowledge of the exact ROs (e.g., RO 902, 904, 906, 908) that are selected, simplifying the measurement process. For example, the receiver implementation may be based on a simple correlation operation in the time domain without a computational-demanding fast Fourier transform (FFT) operation. In some examples, in addition to CLI measurements, the low-complexity receiver, which may operate based on waveform correlation, may also be used for other functionalities. For example, these functionalities may include integrated sensing and communication (ISAC), pre-synchronization signal block (SSB) search, and cell search assisted by wideband FMCW scanning.

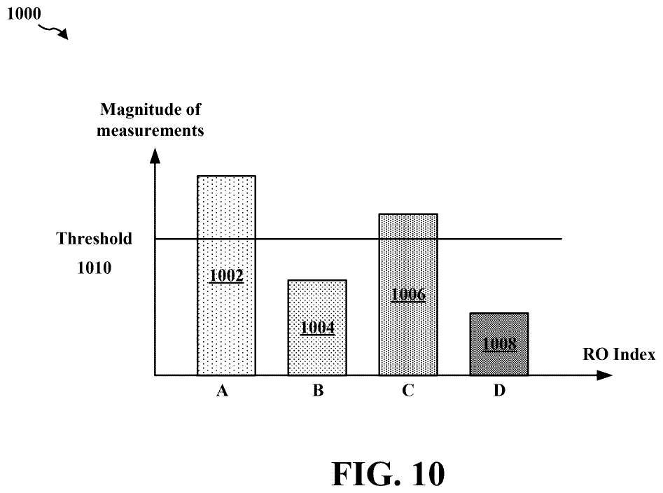

Example aspects further provide a CLI reporting mechanism for PRACH. In some aspects, since the PRACH transmission (e.g., transmission of Msg 1 at 403 or Msg A at 411) may occur randomly for contention-based random access (CBRA) or CBRA-based procedures, a threshold for reference signal received power (RSRP) or received signal strength indicator (RSSI) measurements may be configured and signaled to the UE through, for example, SI, RRC, or MAC-CE to facilitate measurement and reporting. In some examples, the UE may report the measurements (e.g., CLI measurements) for PRACH when certain trigger conditions are met. These trigger conditions may be configured based on specific conditions. For example, the trigger conditions may include the measured signal strength exceeding the threshold configured by the network, exceeding the threshold multiple times (e.g., two times) within a specified time period, exceeding the threshold in consecutive measurements (e.g., two consecutive measurements), or the average value of multiple measurements exceeding the threshold. FIG. 10 is a diagram 1000 illustrating an example of a CLI reporting mechanism based on a threshold in accordance with various aspects of the present disclosure. As shown in FIG. 10, a threshold 1010 for RSRP or RSSI measurements may be configured and signaled to the UE, and the UE may report the CLI measurements for PRACH when the measured signal strength exceeds the threshold 1010. For example, in FIG. 10, the CLI measurements for RO 1002 and 1006 exceed the threshold 1010, and the UE may report the CLI measurements for RO 1002 and 1006. On the other hand, the CLI measurements for RO 1004 and 1008 are lower than the threshold 1010, and the UE may not report the CLI measurements for RO 1004 and 1008.

In some examples, when reporting the measurements (e.g., CLI measurements), the UE may include the RO index (e.g., the RO index for RO 1002 and 1006) or the random access radio network temporary identifier (RA-RNTI) associated with the measurements. For example, for non-coherent measurements, the RO index or RA-RNTI may be reported. In some examples, for coherent measurements, in addition to non-coherent measurements per RO, a UE with advanced capability may detect preamble IDs (e.g., the preamble ID for the preamble at 403) through, for example, correlation and may additionally report the measurement for the detected preamble ID.

In some examples, PRACH measurements and reporting may depend on the UE's capability for CLI detection. For example, as a baseline, a UE capable of measuring PRACH for CLI may conduct non-coherent measurements per RO and report the RO-specific measurements for, for example, RSRP or RSSI. For UEs with advanced capability, preamble detection may be performed, which allows for the reporting of preamble-specific measurements for, for example, RSRP or RSSI.

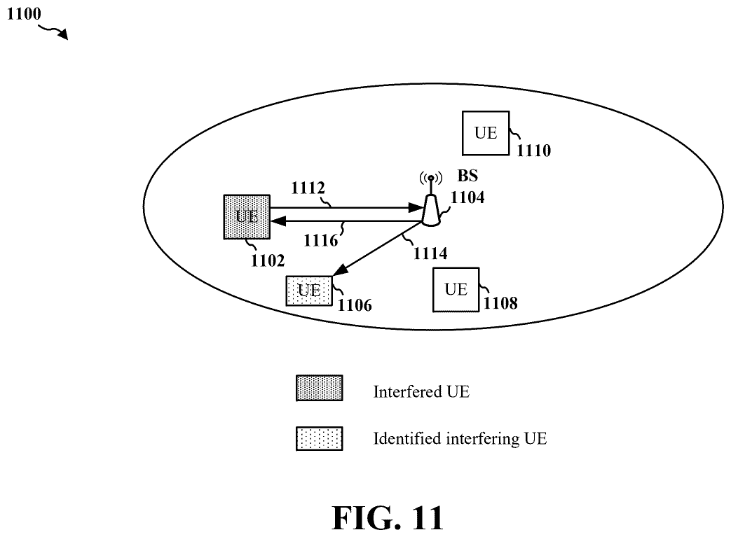

Example aspects presented herein further provide enhancements for CLI management. FIG. 11 is a diagram 1100 illustrating an example of CLI management in accordance with various aspects of the present disclosure. As shown in FIG. 11, in some aspects, UE 1102 may perform CLI measurements with respect to multiple UE (e.g., UE 1106, 1108, 1110) and send a CLI measurement report to the base station 1104 at 1112. Upon receiving a CLI measurement report, the base station 1204 may identify a UE or a group of UEs that are likely to become interfering UEs to one or multiple interfered UEs. For example, the base station 1104 may identify UE 1106 as a possible interfering UE to UE 1102. Depending on the configuration of the measurement report and the processing capability of the base station 1104, this identification (e.g., the identification of interfering UEs) may be performed either during or after the completion of the random access (RA) procedure of the interfering UE (e.g., UE 1106). Based on the timing of the identification (e.g., whether the identification is completed during or after the RA procedure of the interfering UE, such as UE 1106), the base station may manage the potential interfering UEs differently.

In some aspects, if a potential interfering UE performing contention-based random access (CBRA) is identified while in an RRC idle or inactive state before the phase of contention resolution, the network (e.g., base station 1104) may, at 1114, send specific signaling (which may be referred to as a “CLI management message”) to the UE (e.g., UE 1106). This signaling may include, for example, a rejection message for an RRC connection request or an RRC resume request, with CLI management indicated as the cause of rejection if there are one or more interfered UEs (e.g., UE 1102) with higher priority than the interfering UE (e.g., UE 1106). In some examples, the network (e.g., base station 1104) may, at 1114, send to the UE (e.g., UE 1106) a bandwidth part (BWP) switching command or an RRC reconfiguration message related to SDT, positioning—SRS, and RF sensing.

In some aspects, if the potential interfering UE (e.g., UE 1106) is identified after the phase of contention resolution, the network (e.g., base station 1104) may, at 1114, send specific signaling (e.g., “CLI management message”) to the UE (e.g., UE 1106). This signaling may include a BWP reconfiguration message in RRC or a BWP switching command in downlink control information (DCI) or MAC-CE. In some examples, the network (e.g., base station 1104) may send to the UE (e.g., UE 1106) an RRC reconfiguration message for semi-static uplink transmissions, such as time-domain resource allocation (TDRA), frequency-domain resource allocation (FDRA), and periodic transmissions, including configured grant physical uplink shared channel (CG-PUSCH), SRS, and physical uplink control channel (PUCCH). In some examples, the network (e.g., base station 1104) may send to the UE (e.g., UE 1106) signaling including a transmit power control (TPC) command in DCI or MAC-CE, or an RRC reconfiguration message for power control parameters. Additionally, if one or more interfered UEs (e.g., UE 1102) with higher priority than the interfering (e.g., UE 1106) are present, the network (e.g., base station 1104) may send to the UE (e.g., UE 1106) an HO command via RRC or the physical downlink control channel (PDCCH).

In some aspects, to support enhanced CLI management, new signaling formats and elements in RRC, MAC-CE, and DCI may be provided, enabling more efficient network control and mitigation of CLI.

In some aspects, a two-step CLI management may be provided. For example, based on early detection of a potential CLI interfering UE (e.g., a UE whose transmission potentially causes CLI), the network (e.g., base station) may trigger refined CLI measurements and reports. This mechanism allows for priority handling of different service types, supports the coexistence of different UE capabilities, and enhances the flexibility of interference management. Additionally, it helps reduce the false alarm rate in identifying an interfering UE.

In some aspects, in a two-step CLI management procedure, the first step may involve early detection of a potential CLI interfering UE (e.g., UE 1106) when the interfering UE is transmitting PRACH, SRS, or other reference signals associated with positioning or RF sensing during RA or RA-based procedures, such as SDT or HO. In some examples, to minimize reporting overhead in this step, the resource ID of the potential interfering UE (e.g., UE 1106), which may be the RO index, RA-RNTI, or preamble ID, may be reported, while the RSRP/RSSI measurements may be compressed or omitted.

In some examples, in the second step, a UE (e.g., UE 1102) that has reported a potential CLI interfering UE (e.g., UE 1106) in the first step may be assigned, at 1116, a new set of resources for refined CLI measurements and reporting as the second step. For example, once the interfering UE's identity has been confirmed in the second step, the network (e.g., base station 1104) executes the CLI management procedures described previously. For example, if the interfering UE (e.g., UE 1106) is identified before the phase of contention resolution, the network (e.g., base station) may send to the interfering UE (e.g., UE 1106) signaling such as a rejection message for an RRC connection request or an RRC resume request, with CLI management indicated as the cause of rejection, a BWP switching command or an RRC reconfiguration message related to SDT, positioning—SRS, and RF sensing. In some examples, if the interfering UE (e.g., UE 1106) is identified after the phase of contention resolution, the network (e.g., base station 1104) may send to the interfering UE (e.g., UE 1106) signaling such as a BWP reconfiguration message in RRC or a BWP switching command in DCI or MAC-CE, an RRC reconfiguration message for semi-static uplink transmissions, such as TDRA, FDRA, and periodic transmissions, including CG-PUSCH, SRS, and PUCCH. In some examples, if the interfering UE (e.g., UE 1106) is identified after the phase of contention resolution, the network (e.g., base station 1104) may send to the UE (e.g., UE 1106) signaling such as a TPC command in DCI or MAC-CE, an RRC reconfiguration message for power control parameters, or an HO command via RRC or the PDCCH. In some examples, if a UE (e.g., UE 1102) performs CLI measurements in both the first step and the second step, the network (e.g., base station 1104) may provide filtering parameters to ensure that the CLI measurements are effectively combined and reported in the second step.

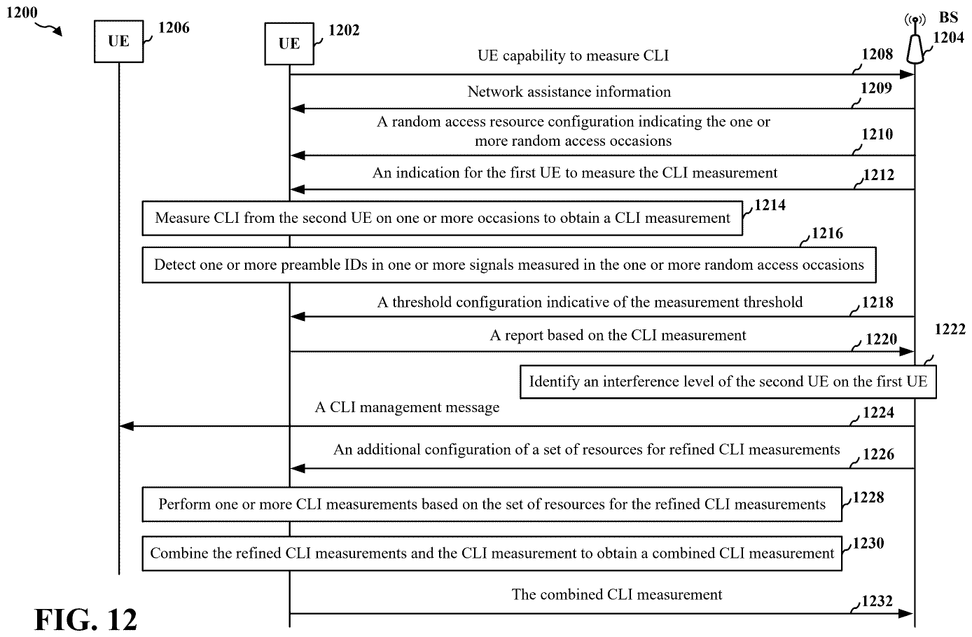

FIG. 12 is a call flow diagram 1200 illustrating a method of wireless communication in accordance with various aspects of this present disclosure. Various aspects are described in connection with a first UE 1202, a second UE 1206, and a base station 1204. The aspects may be performed by the first UE 1202, the second UE 1206, or the base station 1204 in aggregation and/or by one or more components of a base station 1204 (e.g., a CU 110, a DU 130, and/or an RU 140). The first UE 1202 may be an interfered UE (e.g., UE 504, 554, 1102) with respect to the CLI, and the second UE 1206 may be an interfering UE (e.g., UE 502, 552, 1106) with respect to the CLI.

As shown in FIG. 12, at 1208, the first UE 1202 (the interfered UE) may report to the base station 1204 its capabilities to measure CLI on one or more occasions. The one or more occasions may be associated with, for example, random access procedure of the second UE 1206, SDT by the second UE 1206, positioning of the second UE 1206, RF sensing of the second UE 1206, or a HO of the second UE 1206.

Based on the reported capabilities at 1208, the base station 1204 may determine the necessary resources needed for CLI measurement reporting by the first UE 1202. In some examples, the base station 1204 may, at 1209, provide network assistance information to the first UE 1202, either proactively or on-demand based on a request, to facilitate the performance of CLI measurements at the first UE 1202. In some examples, the network assistance information provided by base station 1204 may include, for example, a priority indication for CLI measurements when the first UE 1202 is not capable of performing simultaneous CLI measurements and data communication. In some examples, the network assistance information may include the scheduling information of the second UE 1206 (the interfering UE). Based on this scheduling information, the first UE 1202 may determine the appropriate time and location to perform CLI measurements incurred by the second UE 1206. Based on the availability of CLI measurement opportunities obtained from SI or network assistance information (e.g., at 1209), such as RACH resource indication or scheduling information related to SDT, positioning, sensing, or HO, the first UE 1202 may request the base station 1204 to configure resources for reporting CLI measurements.

At 1210, the first UE 1202 may receive a random access resource configuration indicating the one or more random access occasions from base station 1204. For example, the one or more random access occasions may include RO A 602, RO B 604, RO C 606, RO D 608.

At 1212, the first UE 1202 may receive, from base station 1204, an indication for the first UE 1202 to measure the CLI measurement (e.g., the CLI from the second UE 1206). For example, the indication may indicate the first UE 1202 to perform an aperiodic CLI measurement.

At 1214, the first UE 1202 may measure CLI from the second UE 1206 on one or more occasions to obtain a CLI measurement. For example, the one or more occasions may be associated with random access procedure of the second UE 1206, SDT by the second UE 1206, positioning of the second UE 1206, RF sensing of the second UE 1206, or an HO of the second UE 1206. In some examples, the one or more occasions may be the one or more random access occasions (e.g., RO A 602, RO B 604, RO C 606, RO D 608) received from the base station 1204 at 1210.

In some examples, the first UE 1202 may measure CLI from the second UE 1206 while the second UE 1206 is in the RRC idle state of the RRC inactive state. For example, for CLI measurements during the RACH procedure of the second UE 1206, the second UE 1206 (a potential interfering UE) may be in the RRC idle or RRC inactive state. The PRACH resource allocation may be indicated in the SI and may be known to the first UE 1202. Since PRACH occasions are narrowband, the first UE 1202 may scan or sweep multiple PRACH occasions and report the identifiers (IDs) of the PRACH occasions (e.g., via the random access radio network temporary identifier (RA-RNTI)), on which strong CLI is present. In this case, PRACH transmissions from the second UE 1206 may be processed by both the first UE 1202 and the base station 1204. The first UE 1202 does not need to determine the identity of the interfering UE (e.g., the second UE 1206), as the base station 1204 may, based on the first UE 1202's report indicating the indices of PRACH occasions contaminated by CLI, either decline the RRC connection request of the interfering UE (e.g., the second UE 1206) or, if the RRC connection of the interfering UE (e.g., the second UE 1206) has already established, schedule the interfering UE (e.g., the second UE 1206) to other parts of the radio resource grid to mitigate potential CLI to the first UE 1202.

For SDT, positioning, and sensing, these operations may be performed by the second UE 1206 while the second UE 1206 is in an inactive state. In these cases, the identity of the second UE 1206 is known to the base station 1204. As a result, the base station 1204 may provide the first UE 1202 with the scheduling information and resource allocation details of the second UE 1206 as part of the network assistance information (e.g., at 1209).

In some aspects, at 1216, the first UE 1202 may detect one or more preamble identifiers (IDs) in one or more signals measured in the one or more random access occasions.

At 1218, the first UE 1206 may receive from base station 1204 a threshold configuration indicative of the measurement threshold. The first UE 1206 may determine whether to send a report of the CLI measurement (e.g., at 1220) based on the comparison between the CLI measurement (e.g., at 1214) and the measurement threshold.

At 1220, the first UE 1202 may send to base station 1204 a report based on the CLI measurement. In some examples, the first UE 1202 may send to base station 1204 the report if the CLI measurement is greater than the measurement threshold (e.g., at 1218). For example, referring to FIG. 10, the UE may send a report for the CLI measurement (e.g., CLI measurements on RO 1002, 1006) that exceeds the threshold 1010, and the UE may not send a report for the CLI measurement (e.g., CLI measurements on RO 1004, 1008) that is less than the threshold 1010.

At 1222, the base station 1204 may identify the interference level of the second UE 1206 on the first UE 1202 based on the report.

At 1224, the base station 1204 may send a CLI management message to the second UE 1206 based on the identified interference level (e.g., at 1222) and the timing the base station 1204 completes identifying the interference level. In some examples, if the completion time for identifying the interference level of the second UE 1206 is earlier than the completion time of the contention resolution of the second UE 1206, and the CLI management message may include one or more of: a rejection message for rejecting an RRC connection request or an RRC resume request from the second UE 1206, a BWP switching command for the second UE 1206, or an RRC reconfiguration message for the SDT by the second UE 1206, the positioning of the second UE 1206, or the RF sensing of the second UE 1206. In some examples, if the completion time for identifying the interference level of the second UE 1206 is later than the completion time of the contention resolution of the second UE 1206, and the CLI management message may include one or more of: a BWP reconfiguration message, a BWP switching command, a first RRC reconfiguration message for semi-static uplink transmission, a transmit power control (TPC) for the second UE 1206, a second RRC reconfiguration message for a power control parameter for the second UE 1206, or a handover command for the second UE 1206.

In some examples, the base station 1204 may instruct the first UE 1202 to perform refined CLI measurement based on the received report (e.g., at 1220). For example, at 1226, the base station 1204 may provide an additional configuration of a set of resources for refined CLI measurements to the first UE 1202. Referring to FIG. 11, the base station 1104 may, at 1116, provide an additional configuration of a set of resources for refined CLI measurements to UE 1102.

At 1228, upon receiving the set of resources for refined CLI measurements, the first UE 1202 may perform one or more CLI measurements based on the set of resources for the refined CLI measurements.

In some examples, at 1230, the first UE 1202 may combine the refined CLI measurements (e.g., at 1228) and the previous CLI measurement (e.g., at 1214) to obtain a combined CLI measurement.

At 1232, the first UE 1202 may transmit the combined CLI measurement to base station 1204.

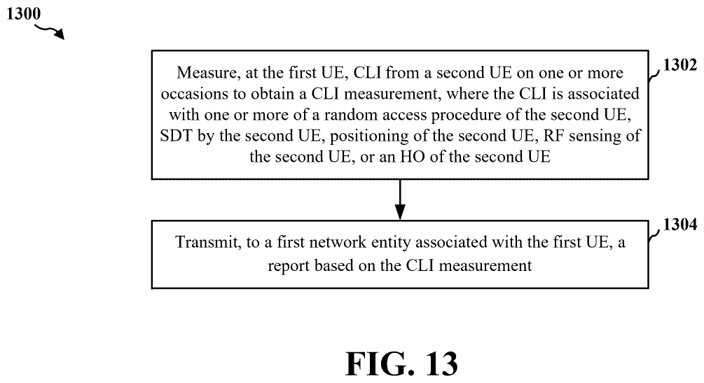

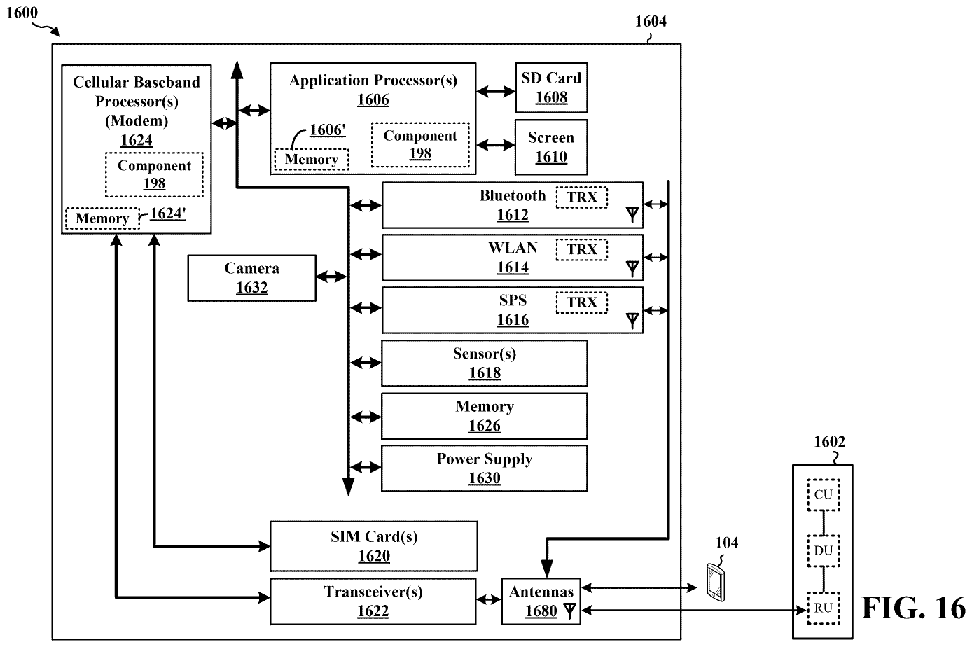

FIG. 13 is a flowchart 1300 illustrating methods of wireless communication at a first UE in accordance with various aspects of the present disclosure. The method may be performed by the first UE in collaboration with a second UE and a first network entity. The first network entity may be a base station, or a component of a base station, in the access network of FIG. 1 or a core network component (e.g., base station 102, 310, 514, 562, 1104, 1204; or the network entity 1602 in the hardware implementation of FIG. 16). The first UE (e.g., interfered UE) may be UE 104, 350, 504, 554, 1102, 1202, or the apparatus 1604 in the hardware implementation of FIG. 16. The second UE (e.g., interfering UE) may be UE 104, 350, 502, 552, 1106, 1206, or the apparatus 1604 in the hardware implementation of FIG. 16. By performing CLI measurement based on physical random access channel (PRACH) signals, the methods enable early interference identification before the interfering UE transitions to active transmission states, thereby reducing the impact of CLI on interfered UEs and allowing for proactive interference management. Additionally, by utilizing PRACH resources that are periodically available and broadcast to all UEs, the methods reduce network overhead for CLI measurement configuration while ensuring efficient resource utilization. In some examples, by implementing a two-step CLI management process, in which initial detection allows the network to selectively trigger more refined CLI measurements, the methods improve the accuracy of interference identification and reduce false alarms and unnecessary network actions.

As shown in FIG. 13, at 1302, the first UE may measure, at the first UE, CLI from the second UE on one or more occasions to obtain a CLI measurement. The CLI may be associated with one or more of a random access procedure of the second UE, SDT by the second UE, positioning of the second UE, RF sensing of the second UE, or an HO of the second UE. FIG. 6, FIG. 7, FIG. 8, FIG. 9, FIG. 10, FIG. 11, and FIG. 12 illustrate various aspects of the steps in connection with flowchart 1300. For example, referring to FIG. 12, the first UE 1202 may, at 1214, measure, at the first UE 1202, CLI from the second UE 1206 on one or more occasions to obtain a CLI measurement. The CLI may be associated with one or more of a random access procedure of the second UE 1206, SDT by the second UE 1206, positioning of the second UE 1206, RF sensing of the second UE 1206, or an HO of the second UE 1206. The CLI may be associated with the random access procedure of the second UE, SDT by the second UE, positioning of the second UE, RF sensing of the second UE, or an HO of the second UE based on the network assistance information provided by the base station 1204. For example, based on the reported capabilities at 1208, the base station 1204 may determine the necessary resources needed for CLI measurement reporting by the first UE 1202, and, at 1209, provide network assistance information to the first UE 1202, to facilitate the performance of CLI measurements at the first UE 1202. In some examples, the network assistance information may include the scheduling information of the second UE 1206. Based on this scheduling information, the first UE 1202 may determine the appropriate time and location to perform CLI measurements incurred by the second UE 1206. Based on the availability of CLI measurement opportunities obtained from SI or network assistance information (e.g., at 1209), such as RACH resource indication or scheduling information related to SDT, positioning, sensing, or HO, the first UE 1202 may request the base station 1204 to configure resources for reporting CLI measurements. In some aspects, 1302 may be performed by the CLI measurement component 198.

At 1304, the first UE may transmit a report based on the CLI measurement to the first network entity associated with the first UE. For example, referring to FIG. 12, the first UE 1202 may, at 1220, transmit a report based on the CLI measurement to the first network entity (e.g., base station 1204) associated with the first UE 1202. In some aspects, 1304 may be performed by the CLI measurement component 198.

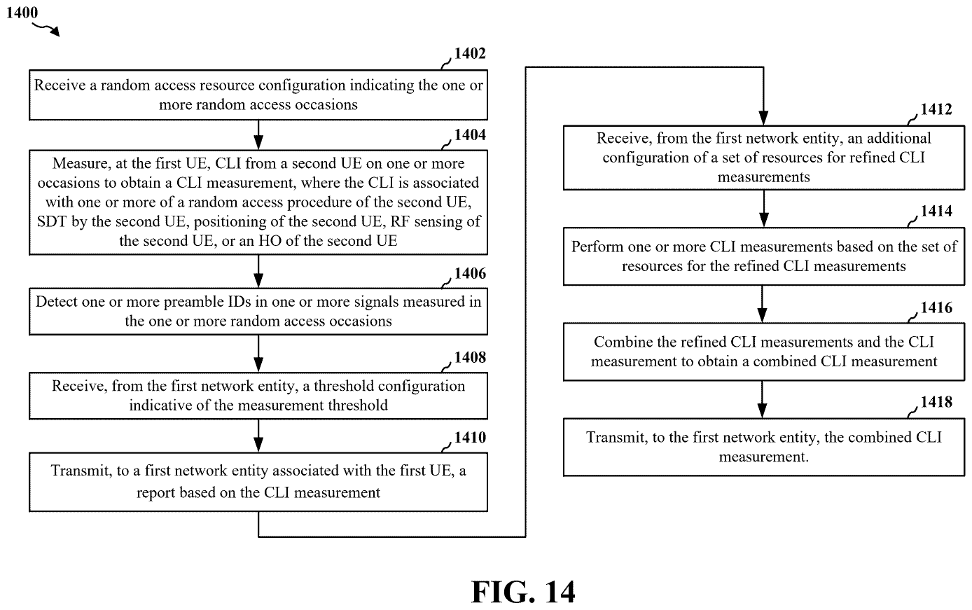

FIG. 14 is a flowchart 1400 illustrating methods of wireless communication at a first UE in accordance with various aspects of the present disclosure. The method may be performed by the first UE in collaboration with a second UE and a first network entity. The first network entity may be a base station, or a component of a base station, in the access network of FIG. 1 or a core network component (e.g., base station 102, 310, 514, 562, 1104, 1204; or the network entity 1602 in the hardware implementation of FIG. 16). The first UE (e.g., interfered UE) may be UE 104, 350, 504, 554, 1102, 1202, or the apparatus 1604 in the hardware implementation of FIG. 16. The second UE (e.g., interfering UE) may be UE 104, 350, 502, 552, 1106, 1206, or the apparatus 1604 in the hardware implementation of FIG. 16. By performing CLI measurement based on physical random access channel (PRACH) signals, the methods enable early interference identification before the interfering UE transitions to active transmission states, thereby reducing the impact of CLI on interfered UEs and allowing for proactive interference management. Additionally, by utilizing PRACH resources that are periodically available and broadcast to all UEs, the methods reduce network overhead for CLI measurement configuration while ensuring efficient resource utilization. In some examples, by implementing a two-step CLI management process, in which initial detection allows the network to selectively trigger more refined CLI measurements, the methods improve the accuracy of interference identification and reduce false alarms and unnecessary network actions.

As shown in FIG. 14, at 1404, the first UE may measure, at the first UE, CLI from the second UE on one or more occasions to obtain a CLI measurement. The CLI may be associated with one or more of a random access procedure of the second UE, SDT by the second UE, positioning of the second UE, RF sensing of the second UE, or an HO of the second UE. FIG. 6, FIG. 7, FIG. 8, FIG. 9, FIG. 10, FIG. 11, and FIG. 12 illustrate various aspects of the steps in connection with flowchart 1400. For example, referring to FIG. 12, the first UE 1202 may, at 1214, measure, at the first UE 1202, CLI from the second UE 1206 on one or more occasions to obtain a CLI measurement. The CLI may be associated with one or more of a random access procedure of the second UE 1206, SDT by the second UE 1206, positioning of the second UE 1206, RF sensing of the second UE 1206, or an HO of the second UE 1206. The CLI may be associated with the random access procedure of the second UE, SDT by the second UE, positioning of the second UE, RF sensing of the second UE, or an HO of the second UE based on the network assistance information provided by the base station 1204. For example, based on the reported capabilities at 1208, the base station 1204 may determine the necessary resources needed for CLI measurement reporting by the first UE 1202, and, at 1209, provide network assistance information to the first UE 1202, to facilitate the performance of CLI measurements at the first UE 1202. In some examples, the network assistance information may include the scheduling information of the second UE 1206. Based on this scheduling information, the first UE 1202 may determine the appropriate time and location to perform CLI measurements incurred by the second UE 1206. Based on the availability of CLI measurement opportunities obtained from SI or network assistance information (e.g., at 1209), such as RACH resource indication or scheduling information related to SDT, positioning, sensing, or HO, the first UE 1202 may request the base station 1204 to configure resources for reporting CLI measurements. In some aspects, 1404 may be performed by the CLI measurement component 198.

At 1410, the first UE may transmit a report based on the CLI measurement to the first network entity associated with the first UE. For example, referring to FIG. 12, the first UE 1202 may, at 1220, transmit a report based on the CLI measurement to the first network entity (e.g., base station 1204) associated with the first UE 1202. In some aspects, 1410 may be performed by the CLI measurement component 198.

In some aspects, the one or more occasions may include one or more random access occasions of the second UE associated with the random access procedure of the second UE, and to measure the CLI (e.g., at 1404), the first UE may measure a random access transmission from the second UE in one of the RRC idle state or the RRC inactive state. For example, referring to FIG. 6 and FIG. 12, the one or more occasions (e.g., at 1214) may include one or more random access occasions (e.g., RO A 602, RO B 604, RO C 606, RO D 608) associated with the random access procedure of the second UE 1206. To measure the CLI (e.g., at 1214), the first UE 1202 may measure a random access transmission (e.g., transmission of Msg 1 at 403 or Msg A at 411) from the second UE 1206 in one of the RRC idle state or the RRC inactive state.

In some aspects, at 1402, the first UE may receive a random access resource configuration indicating the one or more random access occasions. To measure the CLI (e.g., at 1404), the first UE may measure the CLI in the one or more random access occasions. For example, referring to FIG. 12, the first UE 1202 may, at 1210, receive a random access resource configuration indicating the one or more random access occasions (e.g., RO A 602, RO B 604, RO C 606, RO D 608). To measure the CLI (e.g., at 1214), the first UE 1202 may measure the CLI in the one or more random access occasions (e.g., RO A 602, RO B 604, RO C 606, RO D 608). In some aspects, 1402 may be performed by the CLI measurement component 198.

In some aspects, the random access resource configuration may be included in SI from a serving cell of the first UE and the second UE. For example, referring to FIG. 12, the random access resource configuration (e.g., at 1210) may be included in SI from a serving cell (e.g., base station 1204) of the first UE 1202 and the second UE 1206.

In some aspects, the random access resource configuration may be for a non-serving cell of the first UE and may be received (e.g., at 1402) in one of: SI from the non-serving cell, or network assistance information from a serving cell of the first UE. For example, referring to FIG. 12, the random access resource configuration (e.g., at 1210) may be for a non-serving cell of the first UE 1202 and may be received in one of: SI from the non-serving cell, or network assistance information (e.g., at 1209) from a serving cell (e.g., base station 1204) of the first UE 1202. For example, the network assistance information (e.g., at 1209) from base station 1204 may include the availability of CLI measurement opportunities, such as RACH resource indication or scheduling information for SDT, positioning, sensing, or HO.

In some aspects, the frequency ranges of the one or more random access occasions may at least partially overlap with an active downlink BWP of the first UE. For example, referring to FIG. 6, the frequency ranges of the one or more random access occasions (e.g., RO A 602, RO B 604, RO C 606, RO D 608) may at least partially overlap with an active DL BWP 620 of the first UE 1202.

In some aspects, a random access resource configuration may include a plurality of random access occasions, and the CLI measurement may be performed (e.g., at 1404) for the one or more random access occasions. The frequency ranges of the one or more random access occasion may at least partially overlap the active BWP of the first UE. For example, referring to FIG. 12, a random access resource configuration (e.g., 1210) may include a plurality of random access occasions, and the CLI measurement may be performed (e.g., at 1214) for the one or more random access occasions whose frequency ranges at least partially overlap the active BWP of the first UE 1202.

In some aspects, when measuring the CLI between the first UE and the second UE (e.g., at 1404), the first UE may perform a periodic CLI measurement. For example, referring to FIG. 12, the first UE 1202 may, at 1214, perform a periodic CLI measurement. For example, the periodicity of the CLI measurements may be based on the network assistance information provided by base station 1204. For example, the network assistance information may include the scheduling information of the second UE 1206, such as the periodicity of the random access occasions or occasions for SDT, positioning, sensing, or HO at the second UE 1206. The first UE 1202 may perform periodic CLI measurements based on this periodicity.

In some aspects, when measuring the CLI (e.g., at 1404), the first UE may measure the CLI between the first UE and the second UE aperiodically based on a trigger signal from the first network entity. For example, referring to FIG. 12, the first UE 1202 may, at 1214, measure the CLI between the first UE 1202 and the second UE 1206 aperiodically based on a trigger signal (e.g., the indication to measure the CLI measurement at 1212) from the first network entity (e.g., base station 1204). As an example, when an interfering UE (e.g., UE 1206) performs RACH during an HO or SCell switching, the first network entity (e.g., base station 1204) may send a trigger signal to the first UE 1202 to trigger to initiate an aperiodic CLI measurement.

In some aspects, when measuring the CLI in the one or more occasions (e.g., at 1404), the first UE may measure the CLI based on an up-sweep frequency-modulated continuous wave (FMCW) component and a down-sweep FMCW component. For example, referring to FIG. 7, the first UE 1202 may measure the CLI (e.g., at 1214) based on an up-sweep FMCW component (e.g., 712) and a down-sweep FMCW component (e.g., 714).

In some aspects, the cross point of the up-sweep FMCW component and the down-sweep FMCW component may be located at the center of one random access occasion of the one or more random access occasions in the frequency domain or the time domain. For example, referring to FIG. 7, the cross point (e.g., P 740) of the up-sweep component 712 and the down-sweep component 714) may be located at the center of one random access occasion (e.g., RO 750) of the one or more random access occasions in the frequency domain or the time domain.

In some aspects, the up-sweep FMCW component and the down-sweep FMCW component may encompass the one or more random access occasions in the time domain and the frequency domain. For example, referring to FIG. 9, the up-sweep FMCW component 912 and the down-sweep FMCW component 914 may encompass the one or more random access occasions (e.g., RO 902, 904, 906, 908) in the time domain and the frequency domain.

In some aspects, when transmitting the report (e.g., at 1410), the first UE may transmit the report when the CLI measurement exceeds a measurement threshold. For example, referring to FIG. 10, the first UE may transmit the report when the CLI measurement (e.g., CLI measurement on RO 1002, 1006) exceeds a measurement threshold (e.g., threshold 1010).

In some aspects, at 1408, the first UE may receive a threshold configuration indicative of the measurement threshold from the first network entity. For example, referring to FIG. 12, the first UE 1202 may, at 1218, receive a threshold configuration indicative of the measurement threshold (e.g., threshold 1010) from the first network entity (e.g., base station 1204). In some aspects, 1408 may be performed by the CLI measurement component 198.

In some aspects, the report (e.g., at 1410) may include one or more of: indices of the one or more random access occasions, or random access radio network temporary identifier (RA-RNTI) associated with the CLI measurement. For example, referring to FIG. 12, the report (e.g., at 1220) may include one or more of: indices of the one or more random access occasions (e.g., RO 902, 904, 906, 908), or RA-RNTI associated with the CLI measurement.

In some aspects, at 1406, the first UE may detect one or more preamble identifiers (IDs) in one or more signals measured in the one or more random access occasions, and the report (e.g., at 1410) may further include the one or more preamble IDs. For example, referring to FIG. 12, the first UE 1202 may, at 1216, detect one or more preamble IDs in one or more signals measured in the one or more random access occasions (e.g., RO 902, 904, 906, 908), and the report (e.g., at 1220) may further include the one or more preamble IDs. In some aspects, 1406 may be performed by the CLI measurement component 198.

In some aspects, the first UE may, at 1412, receive from the first network entity an additional configuration of a set of resources for refined CLI measurements, and, at 1414, perform one or more CLI measurements based on the set of resources for the refined CLI measurements. For example, referring to FIG. 12, the first UE 1202 may, at 1226, receive from the first network entity (e.g., base station 1204) an additional configuration of a set of resources for refined CLI measurements. The first UE 1202 may, at 1228, perform one or more CLI measurements based on the set of resources for the refined CLI measurements. In some aspects, 1412 and 1414 may be performed by the CLI measurement component 198.

In some aspects, the first UE may, at 1416, combine the refined CLI measurements and the CLI measurement to obtain a combined CLI measurement, and, at 1418, transmit the combined CLI measurement to the first network entity. For example, referring to FIG. 12, the first UE 1202 may, at 1230, combine the refined CLI measurements and the CLI measurement to obtain a combined CLI measurement. The first UE 1202 may, at 1232, transmit the combined CLI measurement to the first network entity (e.g., base station 1204). In some aspects, 1416 and 1418 may be performed by the CLI measurement component 198.

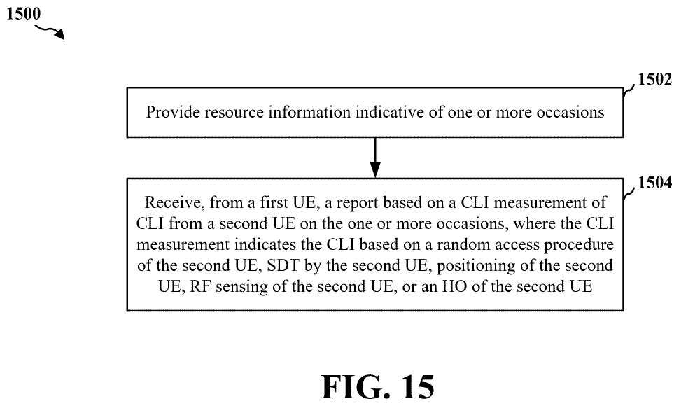

FIG. 15 is a flowchart 1500 illustrating methods of wireless communication at a network entity in accordance with various aspects of the present disclosure. The method may be performed by a network entity in collaboration with a first UE and a second UE. The network entity may be a base station, or a component of a base station, in the access network of FIG. 1 or a core network component (e.g., base station 102, 310, 514, 562, 1104, 1204; or the network entity 1602 in the hardware implementation of FIG. 16). The first UE (e.g., interfered UE) may be UE 104, 350, 504, 554, 1102, 1202, or the apparatus 1604 in the hardware implementation of FIG. 16. The second UE (e.g., interfering UE) may be UE 104, 350, 502, 552, 1106, 1206, or the apparatus 1604 in the hardware implementation of FIG. 16. By performing CLI measurement based on physical random access channel (PRACH) signals, the methods enable early interference identification before the interfering UE transitions to active transmission states, thereby reducing the impact of CLI on interfered UEs and allowing for proactive interference management. Additionally, by utilizing PRACH resources that are periodically available and broadcast to all UEs, the methods reduce network overhead for CLI measurement configuration while ensuring efficient resource utilization. In some examples, by implementing a two-step CLI management process, in which initial detection allows the network to selectively trigger more refined CLI measurements, the methods improve the accuracy of interference identification and reduce false alarms and unnecessary network actions.

As shown in FIG. 15, at 1502, the network entity may provide resource information indicative of one or more occasions. FIG. 6, FIG. 7, FIG. 8, FIG. 9, FIG. 10, FIG. 11, and FIG. 12 illustrate various aspects of the steps in connection with flowchart 1500. For example, referring to FIG. 12, the network entity (e.g., base station 1204) may, at 1210, provide resource information (e.g., a random access resource configuration) indicative of one or more occasions (e.g., RO 902, 904, 906, 908). In some aspects, 1502 may be performed by the CLI measurement component 199.

At 1504, the network entity may receive, from the first UE, a report based on a CLI measurement of CLI from the second UE on the one or more occasions. The CLI measurement may indicate the CLI based on a random access procedure of the second UE, SDT by the second UE, positioning of the second UE, RF sensing of the second UE, or an HO of the second UE. For example, referring to FIG. 12, the network entity (e.g., base station 1204) may, at 1220, receive, from the first UE 1202, a report based on a CLI measurement of CLI from the second UE 1206 on the one or more occasions (e.g., RO 902, 904, 906, 908). The CLI measurement may indicate the CLI based on a random access procedure of the second UE 1206, SDT by the second UE 1206, positioning of the second UE 1206, RF sensing of the second UE 1206, or an HO of the second UE 1206. In some aspects, 1504 may be performed by the CLI measurement component 199.

In some aspects, the network entity may identify an interference level of the second UE on the first UE based on the report. For example, referring to FIG. 12, the network entity (e.g., base station 1204) may, at 1222, identify an interference level of the second UE 1206 on the first UE 1202 based on the report (e.g., at 1220).

In some aspects, a first completion time for identifying the interference level of the second UE may be earlier than a second completion time of a contention resolution of the second UE, and the network entity may transmit, to the second UE based on the interference level, one or more of: a rejection message for rejecting an RRC connection request or an RRC resume request from the second UE, a BWP switching command, or an RRC reconfiguration message for the SDT by the second UE, the positioning of the second UE or the RF sensing of the second UE. For example, referring to FIG. 12, if the completion time for identifying the interference level of the second UE 1206 is earlier than the completion time of a contention resolution of the second UE 1206, the network entity (e.g., base station 1204) may transmit, to the second UE 1206 based on the interference level, one or more of: a rejection message for rejecting an RRC connection request or an RRC resume request from the second UE 1206, a BWP switching command, or an RRC reconfiguration message for the SDT by the second UE 1206, the positioning of the second UE 1206 or the RF sensing of the second UE 1206.

In some aspects, a first completion time for identifying the interference level of the second UE may be later than a second completion time of a contention resolution of the second UE, and the network entity may transmit, to the second UE, based on the interference level, one or more of: a BWP reconfiguration message, a BWP switching command, a first RRC reconfiguration message for semi-static uplink transmission, a transmit power control (TPC) for the second UE, a second RRC reconfiguration message for a power control parameter for the second UE, or a handover command for the second UE. For example, referring to FIG. 12, if the completion time for identifying the interference level of the second UE 1206 is later than the completion time of a contention resolution of the second UE 1206, the network entity (e.g., base station 1204) may transmit, at 1224, to the second UE 1206, a CLI management message. The CLI management message may include one or more: a BWP reconfiguration message, a BWP switching command, a first RRC reconfiguration message for semi-static uplink transmission, a TPC for the second UE 1206, a second RRC reconfiguration message for a power control parameter for the second UE 1206, or a handover command for the second UE 1206.

In some aspects, the one or more occasions (e.g., at 1502) may include one or more random access occasions, and the report (e.g., at 1504) may indicate the CLI measurement based on a random access transmission of the second UE in one of a radio resource control (RRC) idle state or an RRC inactive state. For example, referring to FIG. 12, the one or more occasions may include one or more random access occasions (e.g., RO 902, 904, 906, 908), and the report (e.g., at 1220) may indicate the CLI measurement based on a random access transmission of the second UE 1206 in one of an RRC idle state or an RRC inactive state.

In some aspects, to provide the resource information (e.g., at 1502), the network entity may provide a random access resource configuration indicating the one or more random access occasions, and the CLI measurement (e.g., at 1504) may be measured in the one or more random access occasions. For example, referring to FIG. 12, the network entity (e.g., base station 1204) may, at 1210, provide a random access resource configuration indicating the one or more random access occasions, and the CLI measurement (e.g., at 1214) may be measured in the one or more random access occasions.

In some aspects, the random access resource configuration may be provided in system information (SI) from a serving cell of the first UE and the second UE. For example, referring to FIG. 12, the random access resource configuration (e.g., at 1210) may be provided in SI from a serving cell (e.g., base station 1204) of the first UE 1202 and the second UE 1206.

In some aspects, the random access resource configuration may be for a non-serving cell of the first UE and may be provided in one of: system information (SI) from the non-serving cell, or network assistance information from a serving cell of the first UE. For example, referring to FIG. 12, the random access resource configuration may be for a non-serving cell of the first UE 1202 and may be provided in one of: SI from the non-serving cell, or network assistance information from a serving cell (e.g., base station 1204) of the first UE 1202.

In some aspects, the CLI measurement may be for the one or more random access occasions whose frequency ranges at least partially overlap an active bandwidth part (BWP) of the first UE. For example, referring to FIG. 6, the CLI measurement may be for the one or more random access occasions (e.g., RO A 602, RO B 604, RO C 606, RO D 608), the frequency ranges of the one or more random access occasions (e.g., RO A 602, RO B 604, RO C 606, RO D 608) may at least partially overlap an active BWP (e.g., 620) of the first UE 1202.

In some aspects, the CLI measurement may be a periodic CLI measurement. For example, referring to FIG. 12, the CLI measurement (e.g., at 1214) may be a periodic CLI measurement.

In some aspects, the network entity may send an indication for the first UE to measure the CLI measurement, and the report may be based on an aperiodic CLI measurement in response to the indication. For example, referring to FIG. 12, the network entity (e.g., base station 1204) may, at 1212, send an indication for the first UE 1202 to measure the CLI measurement (e.g., at 1214), and the report (e.g., at 1220) may be based on an aperiodic CLI measurement in response to the indication.

In some aspects, the CLI measurement may be based on an up-sweep FMCW component and a down-sweep FMCW component. For example, referring to FIG. 7 and FIG. 12, the CLI measurement (e.g., at 1214) may be based on an up-sweep FMCW component (e.g., 712) and a down-sweep FMCW component (e.g., 714).

In some aspects, the cross point of the up-sweep FMCW component and the down-sweep FMCW component in the frequency-time domain may be located at the center of one random access occasion of the one or more random access occasions in the frequency-time domain. For example, referring to FIG. 7, the cross point (e.g., P 740) of the up-sweep component 712 and the down-sweep component 714) in the frequency-time domain may be located at the center of one random access occasion (e.g., RO 750) of the one or more random access occasions in the frequency-time domain.

In some aspects, the up-sweep FMCW component and the down-sweep FMCW component may encompass the one or more random access occasions in a time domain and a frequency domain. For example, referring to FIG. 9, the up-sweep FMCW component 912 and the down-sweep FMCW component 914 may encompass the one or more random access occasions (e.g., RO 902, 904, 906, 908) in the time domain and the frequency domain.

In some aspects, the report may be based on the CLI measurement exceeding a measurement threshold. For example, referring to FIG. 10, the first UE 1202 may transmit the report at 1220 when the CLI measurement (e.g., CLI measurement on RO 1002, 1006) exceeds a measurement threshold (e.g., threshold 1010).

In some aspects, the network entity may provide a threshold configuration indicative of the measurement threshold. For example, referring to FIG. 12, the network entity (e.g., base station 1204) may, at 1218, provide a threshold configuration indicative of the measurement threshold (e.g., threshold 1010).

In some aspects, the report may include one or more of: indices of the one or more random access occasions, or random access radio network temporary identifier (RA-RNTI) associated with the CLI measurement. For example, referring to FIG. 12, the report (e.g., at 1220) may include one or more of: indices of the one or more random access occasions (e.g., RO 902, 904, 906, 908), or RA-RNTI associated with the CLI measurement.

In some aspects, the report may further include one or more preamble IDs associated with the CLI measurement. For example, referring to FIG. 12, the report (e.g., at 1220) may further include one or more preamble IDs associated with the CLI measurement.

In some aspects, the network entity may provide an additional configuration of a set of resources for refined CLI measurements; and receive one or more CLI measurements based on the set of resources for the refined CLI measurements. For example, referring to FIG. 12, the network entity (e.g., base station 1204) may, at 1226, provide an additional configuration of a set of resources for refined CLI measurements; and, at 1232, receive one or more CLI measurements based on the set of resources for the refined CLI measurements.

In some aspects, the one or more CLI measurements may include a combined CLI measurement based on the refined CLI measurements and the CLI measurement. For example, referring to FIG. 12, the one or more CLI measurements may include a combined CLI measurement (e.g., at 1232) based on the refined CLI measurements (e.g., at 1228) and the CLI measurement (e.g., at 1214).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to measure, at the first UE, CLI from a second UE on one or more occasions to obtain a CLI measurement; and transmit, to a first network entity associated with the first UE, a report based on the CLI measurement. The CLI is associated with one or more of a random access procedure of the second UE, SDT by the second UE, positioning of the second UE, RF sensing of the second UE, or an HO of the second UE. The component 198 may be further configured to perform any of the aspects described in connection with the flowcharts in FIG. 13 and FIG. 14, and/or performed by the UE 1202 in FIG. 12. The component 198 may be within the cellular baseband processor(s) (or processing circuitry) 1624, the application processor(s) (or processing circuitry) 1606, or both the cellular baseband processor(s) (or processing circuitry) 1624 and the application processor(s) (or processing circuitry) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) (or processing circuitry) 1624 and/or the application processor(s) (or processing circuitry) 1606, includes means for measuring, at the first UE, CLI from a second UE on one or more occasions to obtain a CLI measurement, and means for transmitting, to a first network entity associated with the first UE, a report based on the CLI measurement. The CLI is associated with one or more of a random access procedure of the second UE, SDT by the second UE, positioning of the second UE, RF sensing of the second UE, or an HO of the second UE. The apparatus 1604 may further include means for performing any of the aspects described in connection with the flowcharts in FIG. 13 and FIG. 14, and/or aspects performed by the UE 1202 in FIG. 12. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

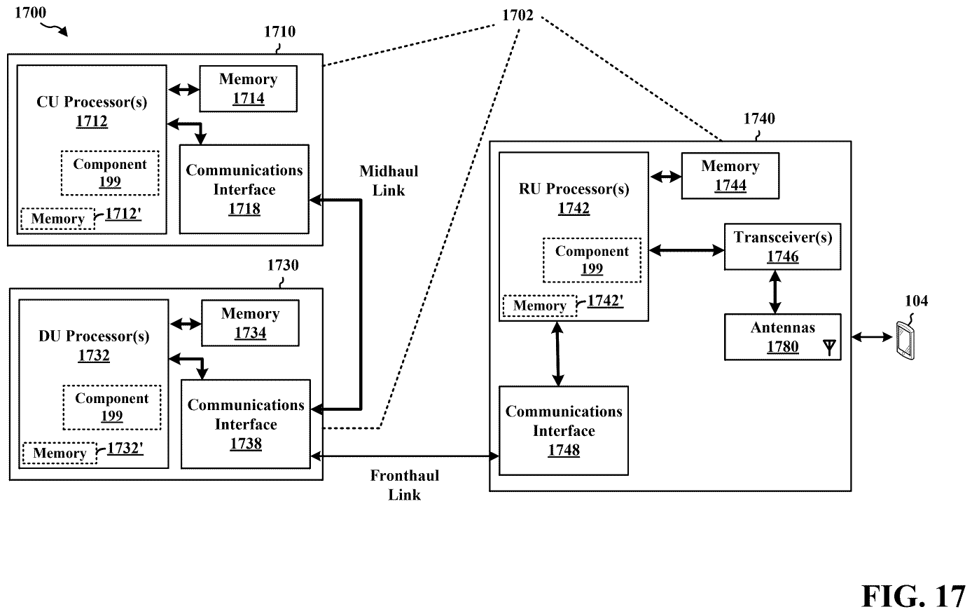

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to provide resource information indicative of one or more occasions; and receive, from a first UE, a report based on a CLI measurement of CLI from a second UE on the one or more occasions. The CLI measurement indicates the CLI based on a random access procedure of the second UE, SDT by the second UE, positioning of the second UE, RF sensing of the second UE, or an HO of the second UE. The component 199 may be further configured to perform any of the aspects described in connection with the flowchart in FIG. 15, and/or performed by the base station 1204 in FIG. 12. The component 199 may be within one or more processors (or processing circuitry) of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for providing resource information indicative of one or more occasions; and means for receiving, from a first UE, a report based on a CLI measurement of CLI from a second UE on the one or more occasions. The CLI measurement indicates the CLI based on a random access procedure of the second UE, SDT by the second UE, positioning of the second UE, RF sensing of the second UE, or an HO of the second UE. The network entity 1702 may further include means for performing any of the aspects described in connection with the flowchart in FIG. 15, and/or aspects performed by the base station 1204 in FIG. 12. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first UE. The method may include measuring, at the first UE, CLI from a second UE on one or more occasions to obtain a CLI measurement; and transmitting, to a first network entity associated with the first UE, a report based on the CLI measurement. The CLI is associated with one or more of a random access procedure of the second UE, SDT by the second UE, positioning of the second UE, RF sensing of the second UE, or an HO of the second UE. By performing CLI measurement based on physical random access channel (PRACH) signals, the methods enable early interference identification before the interfering UE transitions to active transmission states, thereby reducing the impact of CLI on interfered UEs and allowing for proactive interference management. Additionally, by utilizing PRACH resources that are periodically available and broadcast to all UEs, the methods reduce network overhead for CLI measurement configuration while ensuring efficient resource utilization. In some examples, by implementing a two-step CLI management process, in which initial detection allows the network to selectively trigger more refined CLI measurements, the methods improve the accuracy of interference identification and reduce false alarms and unnecessary network actions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊂F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE. The method includes measuring, at the first UE, cross-link interference (CLI) from a second UE on one or more occasions to obtain a CLI measurement, wherein the CLI is associated with one or more of a random access procedure of the second UE, small data transmission (SDT) by the second UE, positioning of the second UE, radio frequency (RF) sensing of the second UE, or a hand over (HO) of the second UE; and transmitting, to a first network entity associated with the first UE, a report based on the CLI measurement.

Aspect 2 is the method of aspect 1, the one or more occasions include one or more random access occasions of the second UE associated with the random access procedure of the second UE, and wherein measuring the CLI includes measuring a random access transmission from the second UE in one of a radio resource control (RRC) idle state or an RRC inactive state.

Aspect 3 is the method of any of aspects 1 to 2, where the method further includes receiving a random access resource configuration indicating the one or more random access occasions, wherein measuring the CLI includes measuring the CLI in the one or more random access occasions.

Aspect 4 is the method of aspect 3, wherein the random access resource configuration is included in system information (SI) from a serving cell of the first UE and the second UE.

Aspect 5 is the method of aspect 3, wherein the random access resource configuration is for a non-serving cell of the first UE and is received in one of: system information (SI) from the non-serving cell, or network assistance information from a serving cell of the first UE.

Aspect 6 is the method of any of aspects 1 to 2, frequency ranges of the one or more random access occasions at least partially overlap with an active downlink bandwidth part (BWP) of the first UE.

Aspect 7 is the method of aspect 6, wherein a random access resource configuration includes a plurality of random access occasions, and the CLI measurement is performed for the one or more random access occasions, wherein the frequency ranges of the one or more random access occasions at least partially overlap the active BWP of the first UE.

Aspect 8 is the method of aspect 6, wherein measuring the CLI between the first UE and the second UE comprises performing a periodic CLI measurement.

Aspect 9 is the method of aspect 6, wherein measuring the CLI comprises: measuring the CLI between the first UE and the second UE aperiodically based on a trigger signal from the first network entity.

Aspect 10 is the method of any of aspects 1 to 2, wherein measuring the CLI in the one or more occasions comprises: measuring the CLI based on an up-sweep frequency-modulated continuous wave (FMCW) component and a down-sweep FMCW component.

Aspect 11 is the method of aspect 10, wherein a cross point of the up-sweep FMCW component and the down-sweep FMCW component is located at a center of one random access occasion of the one or more random access occasions in a frequency domain or a time domain.

Aspect 12 is the method of aspect 10, wherein the up-sweep FMCW component and the down-sweep FMCW component encompass the one or more random access occasions in a time domain and a frequency domain.

Aspect 13 is the method of any of aspects 1 to 2, wherein transmitting the report comprises: transmitting the report in response to the CLI measurement exceeding a measurement threshold.

Aspect 14 is the method of aspect 13, where the method further includes receiving, from the first network entity, a threshold configuration indicative of the measurement threshold.

Aspect 15 is the method of aspect 13, wherein the report includes one or more of: indices of the one or more random access occasions, or random access radio network temporary identifier (RA-RNTI) associated with the CLI measurement.

Aspect 16 is the method of aspect 15, where the method further includes detecting one or more preamble identifiers (IDs) in one or more signals measured in the one or more random access occasions, and wherein the report further includes the one or more preamble IDs.

Aspect 17 is the method of aspect 13, where the method further includes receiving, from the first network entity, an additional configuration of a set of resources for refined CLI measurements; and performing one or more CLI measurements based on the set of resources for the refined CLI measurements.

Aspect 18 is the method of aspect 17, where the method further includes combining the refined CLI measurements and the CLI measurement to obtain a combined CLI measurement; and transmitting, to the first network entity, the combined CLI measurement.

Aspect 19 is an apparatus for wireless communication at a first UE, comprising: at least one memory; and at least one processor coupled to the at least one memory, the at least one processor is configured to perform the method of any of aspects 1 to 18.

Aspect 20 is the apparatus for wireless communication at a first UE, comprising means for performing each step in the method of any of aspects 1-18.

Aspect 21 is an apparatus of any of aspects 19-20, further comprising a transceiver configured to receive or to transmit in association with the method of any of aspects 1-18.

Aspect 22 is a computer-readable medium (e.g., a non-transitory computer-readable medium) storing computer executable code at a first UE, the code when executed by at least one processor causes the at least one processor to perform the method of any of aspects 1-18.

Aspect 23 is a method of wireless communication at a network entity. The method includes providing resource information indicative of one or more occasions; and receiving, from a first user equipment (UE), a report based on a cross-link interference (CLI) measurement of CLI from a second UE on the one or more occasions, wherein the CLI measurement indicates the CLI based on a random access procedure of the second UE, small data transmission (SDT) by the second UE, positioning of the second UE, radio frequency (RF) sensing of the second UE, or a hand over (HO) of the second UE.

Aspect 24 is the method of aspect 23, where the method further includes identifying, based on the report, an interference level of the second UE on the first UE.

Aspect 25 is the method of any of aspects 23 to 24, wherein a first completion time for identifying the interference level of the second UE is earlier than a second completion time of a contention resolution of the second UE, and wherein the method further comprises: transmitting, to the second UE based on the interference level, one or more of: a rejection message for rejecting a radio resource control (RRC) connection request or an RRC resume request from the second UE, a BWP switching command, or an RRC reconfiguration message for the SDT by the second UE, the positioning of the second UE or the RF sensing of the second UE.

Aspect 26 is the method of aspect 24, wherein a first completion time for identifying the interference level of the second UE is later than a second completion time of a contention resolution of the second UE, and wherein the method further comprises: transmitting, to the second UE based on the interference level, one or more of: a bandwidth part (BWP) reconfiguration message, a BWP switching command, a first radio resource control (RRC) reconfiguration message for semi-static uplink transmission, a transmit power control (TPC) for the second UE, a second RRC reconfiguration message for a power control parameter for the second UE, or a handover command for the second UE.

Aspect 27 is the method of aspect 23, wherein the one or more occasions include one or more random access occasions, and wherein the report indicates the CLI measurement based on a random access transmission of the second UE in one of a radio resource control (RRC) idle state or an RRC inactive state.

Aspect 28 is the method of aspect 27, wherein providing the resource information includes: providing a random access resource configuration indicating the one or more random access occasions, wherein the CLI measurement is measured in the one or more random access occasions.

Aspect 29 is the method of aspect 28, wherein the random access resource configuration is provided in system information (SI) from a serving cell of the first UE and the second UE.

Aspect 30 is the method of aspect 28, wherein the random access resource configuration is for a non-serving cell of the first UE and is provided in one of: system information (SI) from the non-serving cell, or network assistance information from a serving cell of the first UE.

Aspect 31 is the method of aspect 27, wherein the CLI measurement is for the one or more random access occasions, wherein frequency ranges of the one or more random access occasions at least partially overlap an active bandwidth part (BWP) of the first UE.

Aspect 32 is the method of aspect 31, wherein the CLI measurement is a periodic CLI measurement.

Aspect 33 is the method of aspect 31, where the method further includes sending an indication for the first UE to measure the CLI measurement, wherein the report is based on an aperiodic CLI measurement in response to the indication.

Aspect 34 is the method of aspect 27, wherein the CLI measurement is based on an up-sweep frequency-modulated continuous wave (FMCW) component and a down-sweep FMCW component.

Aspect 35 is the method of aspect 34, wherein a cross point of the up-sweep FMCW component and the down-sweep FMCW component in a frequency-time domain is located at a center of one random access occasion of the one or more random access occasions in the frequency-time domain.

Aspect 36 is the method of aspect 34, wherein the up-sweep FMCW component and the down-sweep FMCW component encompass the one or more random access occasions in a time domain and a frequency domain.

Aspect 37 is the method of aspect 27, wherein the report is based on the CLI measurement exceeding a measurement threshold.

Aspect 38 is the method of aspect 37, where the method further includes providing a threshold configuration indicative of the measurement threshold.

Aspect 39 is the method of aspect 37, wherein the report includes one or more of: indices of the one or more random access occasions, or random access radio network temporary identifier (RA-RNTI) associated with the CLI measurement.

Aspect 40 is the method of aspect 39, wherein the report further includes one or more preamble identifiers (IDs) associated with the CLI measurement.

Aspect 41 is the method of aspect 37, where the method further includes providing an additional configuration of a set of resources for refined CLI measurements; and receiving one or more CLI measurements based on the set of resources for the refined CLI measurements.

Aspect 42 is the method of aspect 41, wherein the one or more CLI measurements include a combined CLI measurement based on the refined CLI measurements and the CLI measurement.

Aspect 43 is an apparatus for wireless communication at a network entity, comprising: at least one memory; and at least one processor coupled to the at least one memory and, where the at least one processor is configured to perform the method of any of aspects 23-42.

Aspect 44 is the apparatus for wireless communication at a network entity, comprising means for performing each step in the method of any of aspects 23-42.

Aspect 45 is an apparatus of any of aspects 43-44, further comprising a transceiver configured to receive or to transmit in association with the method of any of aspects 23-42.

Aspect 46 is a computer-readable medium (e.g., a non-transitory computer-readable medium) storing computer executable code at a network entity, the code when executed by at least one processor causes the at least one processor to perform the method of any of aspects 23-42.

What is claimed is:

1. An apparatus for wireless communication at a first user equipment (UE), comprising:
at least one memory; and
at least one processor coupled to the at least one memory and, based at least in part on information stored in the at least one memory, the at least one processor is configured to:
measure, at the first UE, cross-link interference (CLI) from a second UE on one or more occasions to obtain a CLI measurement, wherein the CLI is associated with one or more of a random access procedure of the second UE, small data transmission (SDT) by the second UE, positioning of the second UE, radio frequency (RF) sensing of the second UE, or a hand over (HO) of the second UE; and
transmit, to a first network entity associated with the first UE, a report based on the CLI measurement.

2. The apparatus of claim 1, further comprising a transceiver coupled to the at least one processor, wherein to transmit the report, the at least one processor is configured to transmit the report via the transceiver, wherein the one or more occasions include one or more random access occasions of the second UE associated with the random access procedure of the second UE, and wherein to measure the CLI, the at least one processor is configured to:
measure a random access transmission from the second UE in one of a radio resource control (RRC) idle state or an RRC inactive state.

3. The apparatus of claim 2, wherein the at least one processor is further configured to:
receive a random access resource configuration indicating the one or more random access occasions, wherein to measure the CLI, the at least one processor is configured to:
measure the CLI in the one or more random access occasions.

4. The apparatus of claim 3, wherein the random access resource configuration is included in system information (SI) from a serving cell of the first UE and the second UE.

5. The apparatus of claim 3, wherein the random access resource configuration is for a non-serving cell of the first UE and is received in one of:
system information (SI) from the non-serving cell, or
network assistance information from a serving cell of the first UE.

6. The apparatus of claim 2, wherein frequency ranges of the one or more random access occasions at least partially overlap with an active downlink bandwidth part (BWP) of the first UE.

7. The apparatus of claim 6, wherein a random access resource configuration includes a plurality of random access occasions, and the CLI measurement is performed for the one or more random access occasions, wherein the frequency ranges of the one or more random access occasions at least partially overlap the active BWP of the first UE.

8. The apparatus of claim 2, wherein to measure the CLI in the one or more occasions, the at least one processor is configured to:
measure the CLI based on an up-sweep frequency-modulated continuous wave (FMCW) component and a down-sweep FMCW component.

9. The apparatus of claim 8, wherein a cross point of the up-sweep FMCW component and the down-sweep FMCW component is located at a center of one random access occasion of the one or more random access occasions in a frequency domain or a time domain.

10. The apparatus of claim 8, wherein the up-sweep FMCW component and the down-sweep FMCW component encompass the one or more random access occasions in a time domain and a frequency domain.

11. The apparatus of claim 2, wherein to transmit the report, the at least one processor is configured to:
transmit the report in response to the CLI measurement exceeding a measurement threshold.

12. The apparatus of claim 11, wherein the at least one processor is further configured to:
receive, from the first network entity, a threshold configuration indicative of the measurement threshold.

13. The apparatus of claim 11, wherein the report includes one or more of:
indices of the one or more random access occasions, or
random access radio network temporary identifier (RA-RNTI) associated with the CLI measurement.

14. The apparatus of claim 13, wherein the at least one processor is further configured to:
detect one or more preamble identifiers (IDs) in one or more signals measured in the one or more random access occasions, and wherein the report further includes the one or more preamble IDs.

15. The apparatus of claim 11, wherein the at least one processor is further configured to:
receive, from the first network entity, an additional configuration of a set of resources for refined CLI measurements; and
perform one or more CLI measurements based on the set of resources for the refined CLI measurements.

16. The apparatus of claim 15, wherein the at least one processor is further configured to:
combine the refined CLI measurements and the CLI measurement to obtain a combined CLI measurement; and
transmit, to the first network entity, the combined CLI measurement.

17. An apparatus for wireless communication at a network entity, comprising:
at least one memory; and
at least one processor coupled to the at least one memory and, based at least in part on information stored in the at least one memory, the at least one processor is configured to:
provide resource information indicative of one or more occasions; and
receive, from a first user equipment (UE), a report based on a cross-link interference (CLI) measurement of CLI from a second UE on the one or more occasions, wherein the CLI measurement indicates the CLI based on a random access procedure of the second UE, small data transmission (SDT) by the second UE, positioning of the second UE, radio frequency (RF) sensing of the second UE, or a hand over (HO) of the second UE.

18. The apparatus of claim 17, wherein the at least one processor is further configured to:
identify, based on the report, an interference level of the second UE on the first UE.

19. The apparatus of claim 18, wherein a first completion time for identifying the interference level of the second UE is earlier than a second completion time of a contention resolution of the second UE, and wherein the at least one processor is further configured to:
transmitting, to the second UE based on the interference level, one or more of:
a rejection message for rejecting a radio resource control (RRC) connection request or an RRC resume request from the second UE,
a BWP switching command, or
an RRC reconfiguration message for the SDT by the second UE, the positioning of the second UE or the RF sensing of the second UE.

20. A method of wireless communication at a first user equipment (UE), comprising:
measuring, at the first UE, cross-link interference (CLI) from a second UE on one or more occasions to obtain a CLI measurement, wherein the CLI is associated with one or more of a random access procedure of the second UE, small data transmission (SDT) by the second UE, positioning of the second UE, radio frequency (RF) sensing of the second UE, or a hand over (HO) of the second UE; and
transmitting, to a first network entity associated with the first UE, a report based on the CLI measurement.
